(19) United States
(12) Patent Application Publication
(10) Pub. No.: US 2006/0190917 A1
(43) Pub. Date: Aug. 24, 2006

(54) System and process for manufacturing application specific printable circuits (ASPC'S) and other custom electronic devices

(75) Inventor: Chuck Edwards, Rio Rancho, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/331,189

(22) Filed: Jan. 13, 2006

Related U.S. Application Data
(60) Provisional application No. 60/695,411, filed on Jul. 1, 2005.
(60) Provisional application No. 60/643,629, filed on Jan. 14, 2005.
(60) Provisional application No. 60/643,577, filed on Jan. 14, 2005.
(60) Provisional application No. 60/643,578, filed on Jan. 14, 2005.

(51) Int. Cl. G06F 17/50

(52) U.S. Cl. 716/21

(57) ABSTRACT

A system and process for manufacturing custom printed circuit boards on pre-provided substrates, wherein the substrate can be pre-provided with electronic devices. The electronic devices can be pre-provided on the substrate by direct printing, or in a more conventional manner, such as by standard integrated circuit technologies, in many different packing technologies. The user designs the custom printed circuit board using a design tool to perform one or more specific electronic functions, based on the pre-provided electronic devices, and/or custom designed and direct printed electronic devices. The electronic devices includes transistors, resistors, capacitors, among other types of devices. Examples of the electronic functions that can realized using the system and process described herein include, but are not limited to, include an RFID device, and a PROM.

### CROSS REFERENCE TO RELATED APPLICATIONS

This application claims priority to U.S. Provisional Patent Application Ser. Nos. 60/695,411 filed Jul. 1, 2005 and 60/643,577, 60/643,629, and 60/643,378, all filed on Jan. 14, 2005, the entireties of which are incorporated herein by reference.

### BACKGROUND OF THE INVENTION

1. Field of the Invention

The invention relates to direct printing. More particularly, the invention relates to a system and process for non-contact direct printing using conductive particles in an ink solution for dispersion on substrates that contain other electronic circuits to create one or more new electronic functions.

2. Background Art

Printable electronic inks, and other new “paper-like” display technologies such as E Ink, have developed as an advanced process of producing electronics and displays on paper-like materials and films. These low cost electronics promise to dramatically reduce costs and increase the number and variety of applications for electronics and displays into markets which were previously considered too costly. The phrase “disposable electronics” will now come to describe these type of low costs products, and actually be realizable. Examples of such “disposable electronics” include intelligent medical packaging, RFID tags, smart cards and the like.

The problem for many of these applications, however, is that the active devices needed to make them functional (transistors, display components, electronic memory, logic circuits, RFID and radio circuits, and others) often require high precision patterning techniques, clean room environments and other special processes that make them cost prohibitive for regional manufacturing using conventional printing equipment. There have been attempts to try to overcome the costs prohibitions. For example, in the silicon industry, application specific integrated circuits (ASICs) were developed. These ASIC's were pre-patterned with transistor devices (very often with as many as 10,000 to hundreds of thousands of transistors). Often larger functional logic blocks (like a processor or memory circuit) were included and these devices were then called “standard cells.” But, there was no practical way to combine the ASIC's and standard cells with printable electronic inks.

Ink jet (IJ) printing, screen printing and other printing techniques of silver ink and other conductors have been demonstrated. This is a relatively simple and standard process. IJ printing and more exotic patterning techniques have also been used to create transistors on flexible substrates as well. But to date, the printing of semiconductors and displays has required far more complex processes for either organic or inorganic semiconductor materials to be deposited and turned into a functional transistor or other logic devices. Making custom printed circuits on low cost substrates with these processes would therefore require the customer to have either a very complex and sophisticated process equipment with many layers patterned, or originate a custom design for each new device. Furthermore, current circuit manufacturing techniques do not allow for quick and cost-effective customization of conventional or new circuit boards. Therefore, it is very difficult and expensive to modify circuit boards that already have circuitry on them to customize or modify for a new function or use.

Thus, a need exists for printing on non-uniform substrates that overcomes all of the above mentioned difficulties, as well as those not mentioned, and provide the advantages described in greater detail below.

### SUMMARY OF THE INVENTION

It is therefore a general object of the invention to provide a non-contact direct printing system that will obviate or minimize problems of the type previously described.

It is a specific object of the present invention to provide a system and process for printing interconnections between pre-printed, low cost transistors and/or logic cells that have been printed and/or mounted on a low cost substrate with pads of sufficient size to allow printing of the interconnects between these devices.

It is a specific object of the present invention to provide a system and process for printing interconnections between pre-printed, low cost transistors and/or logic cells that have been printed and/or mounted on a low cost substrate with pads of sufficient size to allow printing of the interconnects between these devices such that mass production of circuit functions with more complex semiconductor pre-printed media. It is still a further object of the present invention to provide a system and process for printing interconnections between the more complex semiconductor pre-printed media that can then be customized at a user's convenience by a direct printing process that is done regionally based on a specific circuit design.

The above described disadvantages are overcome and a number of advantages are realized by the present invention which relates to a process for creating a custom printed circuit comprising the steps of a) providing a substrate with one or more electronic devices, wherein each electronic device comprises a plurality of terminals, each of the plurality of terminals electrically connected to at least one or more terminal pads; and b) direct printing one or more conductive paths between the plurality of terminal pads to create one or more custom printed circuits.

According to another embodiment of the present invention a process for creating a custom printed circuit from pre-provided functional blocks of electronic circuits on a substrate is provided comprising the steps of a) designing the custom printed circuit from one or more functional blocks of electronic circuits; and b) direct printing one or more conductive traces between the one or more functional blocks of electronic circuits to form the designed custom printed circuit.

According to still yet another embodiment of the present invention, a process is presented for providing user defined data in a configurable read-only memory device (ROM), wherein the ROM comprises an array of transistors on a substrate, wherein the process comprises the steps of a) direct printing a first interconnect pattern within the array of transistors to provide the user defined data; and b) direct printing a second interconnect pattern to provide external and/or internal access to the user defined data.

According to a further embodiment of the present invention, a process for creating a custom printed circuit from pre-provided functional blocks of electronic circuits and standard integrated circuits is provided comprising the steps of a) designing the custom printed circuit from one or more functional blocks of electronic circuits and at least one or more standard integrated circuits; and b) direct printing one or more conductive traces between the one or more functional blocks of electronic circuits and the at least one or more standard integrated circuits to form the designed custom printed circuit.

According to still a further embodiment of the present invention, a process for creating a membrane keyboard device from a plurality of substrates, wherein each substrate comprises a pre-provided array of transistors and at least one or more standard integrated circuits, is provided, the process comprising the steps of a) direct printing a plurality of conductive traces for a first membrane of the membrane keyboard onto a first substrate, and direct printing a second plurality of conductive traces for a second membrane of the membrane keyboard onto a second substrate; and b) direct printing one or more conductive traces from either or both of one or more transistors from the array of transistors and one or more of the standard integrated circuits to at least one or more of the plurality of traces printed on the first and second membranes.

According to a first aspect of the present invention, a process for creating a custom printed circuit is provided comprising the steps of: a) providing a substrate with one or more electronic devices, wherein each electronic device comprises a plurality of terminals, each of the plurality of terminals electrically connected to at least one or more terminal pads; and b) direct printing one or more conductive paths between the plurality of terminal pads to create one or more custom printed circuits.

According to the first aspect of the present invention, the one or more electronic devices are selected from the group consisting of transistors, resistors, capacitors, inductors, buffer circuits, transmitter and receiver circuits, input/output circuit devices, input/output terminals, memory circuits, line drivers, microprocessors, display devices, and sensor devices. Further still, the one or more electronic devices comprises an array of one or more transistors, or one or more transistors previously interconnected to provide a function of the one or more electronic devices.

According to the first aspect of the present invention, the substrate comprises a flexible, substantially non-rigid substrate, or the substrate comprises a substantially non-flexible, substantially rigid substrate.

According to the first aspect of the present invention, the step of direct printing one or more conductive paths comprises: a) ink jet printing the one or more conductive paths using an ink that comprises conductive particles in a solution; and b) curing the printed ink to create a path with a desired conductivity.

According to the first aspect of the present invention, the process further comprises a) defining one or more interconnection paths between the one or more terminal pads of the one or more electronic devices, wherein such interconnection paths defines a custom printed circuit with an electronic function; b) generating a series of commands to create the one or more interconnection paths for use with a direct printer device; and c) transmitting the series of commands to the direct printer device. The direct printer device comprises an ink jet printer.

According to the first aspect of the present invention, the step of defining one or more interconnection paths between the one or more terminal pads of the one or more electronic devices comprises: a) designing the custom printed circuit from a library that defines the custom printed circuit in terms of the one or more electronic devices provided on the substrate; and b) generating a file comprising the one or more interconnection paths between the one or more terminal pads of the one or more electronic devices from the library that defines the custom printed circuit in terms of the one or more electronic devices provided on the substrate.

According to the first aspect of the present invention, the library is obtained from a computer assisted engineering (CAE) software tool. Further still, the step of defining one or more interconnection paths between the one or more terminal pads of the one or more electronic devices comprises: a) utilizing a design tool that defines the custom printed circuit in terms of the one or more electronic devices provided on the substrate; and b) generating a file comprising the one or more interconnection paths between the one or more terminal pads of the one or more electronic devices from the design tool that defines the custom printed circuit in terms of the one or more electronic devices provided on the substrate.

According to the first aspect of the present invention, the design tool is obtained from a very high speed integrated circuit (VHSIC) hardware description language (VHDL) software tool, and the step of generating a file comprises: a) compiling the file generated by the library comprising the one or more interconnection paths between the one or more terminal pads of the one or more electronic devices into a file that can be read by the direct printer device.

According to the first aspect of the present invention, the custom printed circuit comprises a driver board for a display terminal, an electronic ink display terminal, an electro-chromic display terminal, or a thermo-chromic display terminal.

According to the first aspect of the present invention, the process further comprises printing a resistor device along the conductive path between the plurality of conductive terminal pads to create heat from the resistor device, and the display terminal comprises a polymer dispersed liquid crystal display terminal. The display terminal can also comprise an organic light emitting diode display terminal, a polymer organic light emitting diode display terminal. The custom printed circuit comprises a ROM, or a customized display for a package.

According to a second aspect of the present invention, a process for creating a custom printed circuit from pre-provided functional blocks of electronic circuits on a substrate is provided comprising the steps of: a) designing the custom printed circuit from one or more functional blocks of electronic circuits; and b) direct printing one or more conductive traces between the one or more functional blocks of electronic circuits to form the designed custom printed circuit.

According to the second aspect of the present invention, the step of direct printing comprises: a) ink jet printing the one or more conductive paths using an ink that comprises conductive particles in a solution; and b) curing the printed ink to create a path with a desired conductivity, and the step of designing the custom printed circuit comprises: a) creating an interconnection pattern file to connect the one or more functional blocks of electronic circuits from a library that defines the custom printed circuit in terms of the functional blocks; b) compiling the interconnection pattern file to create a direct printer readable interconnection file; and c) transmitting the direct printer readable interconnection file to the direct printer.

According to the second aspect of the present invention, the library is obtained from a computer assisted engineering (CAE) software tool, and the direct printer device comprises an ink jet printer. According to the second aspect of the present invention, the step of designing the custom printed circuit comprises: a) creating an interconnection pattern file to connect the one or more functional blocks of electronic circuits from a design tool that defines the custom printed circuit in terms of the functional blocks; b) compiling the interconnection pattern file to create a direct printer readable interconnection file; and c) transmitting the direct printer readable interconnection file to the direct printer. The design tool is obtained from a very high speed integrated circuit (VHSIC) hardware description language (VHDL) software tool, and the pre-provided functional blocks of electronic circuits are selected from the group consisting of transistors, resistors, capacitors, inductors, buffer circuits, transmitter and receiver circuits, input/output circuit devices, input/output terminals, memory circuits, line drivers, microprocessors, display devices, and sensor devices. According to the second aspect of the present invention, the one or more pre-provided functional blocks of electronic devices comprises: an array of one or more transistors.

According to the second aspect of the present invention, the process further comprises providing a substrate with one or more transistors that have been direct printed on the substrate, and the step of providing a substrate with one or more transistors that have been direct printed on the substrate comprises: ink jet printing an array of transistors. The pre-provided functional blocks of electronic circuits comprises an e-ink media with flexible substrate with an array of transistors, or a flexible substrate with an array of transistors provided in a fusible read-only memory (ROM) configuration.

According to the second aspect of the present invention, the custom printed circuit comprises: a display device, display driver device or a read-only memory (ROM) device, and the substrate comprises a flexible, substantially non-rigid substrate, or a substantially non-flexible, substantially rigid substrate.

According to a third aspect of the present invention, a process for providing user defined data in a configurable read-only memory device (ROM), wherein the ROM comprises an array of transistors on a substrate is provided comprising the steps of: a) direct printing a first interconnect pattern within the array of transistors to provide the user defined data; and b) direct printing a second interconnect pattern to provide external and/or internal access to the user defined data.

According to the third aspect of the present invention, the step of direct printing an interconnect pattern comprises: a) ink jet printing the interconnect pattern using an ink that comprises conductive particles in a solution; and b) curing the printed ink to create a path with a desired conductivity. The step of direct printing a first interconnect pattern comprises: a) direct printing a first conductive path between a first group of conductive pads associated with a first group of transistors in the array of transistors where a high logic level is desired; and b) not direct printing a conductive path between a second group of conductive pads associated with a second group of transistors in the array of transistors where a low logic level is desired.

According to the third aspect of the present invention, the process further comprises: a) pre-providing one or more functional blocks of electronic circuits on a substrate; b) designing a custom printed circuit from one or more functional blocks of electronic circuits and the ROM; and c) direct printing one or more conductive traces between the one or more functional blocks of electronic circuits to form the designed custom printed circuit.

According to the third aspect of the present invention, the step of direct printing comprises: a) ink jet printing the one or more conductive paths using an ink that comprises conductive particles in a solution; and b) curing the printed ink to create a path with a desired conductivity. The step of designing the custom printed circuit comprises: a) creating an interconnection pattern file to connect the one or more functional blocks of electronic circuits and the ROM from a library that defines the custom printed circuit in terms of the functional blocks; b) compiling the interconnection pattern file to create a direct printer readable interconnection file; and c) transmitting the direct printer readable interconnection file to the direct printer.

According to the third aspect of the present invention, the library is obtained from a computer assisted engineering (CAE) software tool, and the direct printer device comprises an ink jet printer.

According to the third aspect of the present invention, the step of designing the custom printed circuit comprises: a) creating an interconnection pattern file to connect the one or more functional blocks of electronic circuits and the ROM from a design tool that defines the custom printed circuit in terms of the functional blocks; b) compiling the interconnection pattern file to create a direct printer readable interconnection file; and c) transmitting the direct printer readable interconnection file to the direct printer.

According to the third aspect of the present invention, the design tool is obtained from a very high speed integrated circuit (VHSIC) hardware description language (VHDL) software tool, and the pre-provided functional blocks of electronic circuits are selected from the group consisting of transistors, resistors, capacitors, inductors, buffer circuits, transmitter and receiver circuits, input/output circuit devices, input/output terminals, memory circuits, line drivers, microprocessors, display devices, and sensor devices. The one or more pre-provided functional blocks of electronic devices comprises an array of one or more transistors.

According to the third aspect of the present invention, the process further comprises providing a substrate with one or more transistors that have been direct printed on the substrate, and the step of providing a substrate with one or more transistors that have been direct printed on the substrate comprises: ink jet printing an array of transistors.

According to the third aspect of the present invention, the pre-provided functional blocks of electronic circuits comprises: a) an RF antenna and a power source. The substrate comprises a flexible, substantially non-rigid substrate, or the substrate comprises a substantially non-flexible, substantially rigid substrate.

According to a fourth aspect of the present invention, a process for creating a custom printed circuit from pre-provided functional blocks of electronic circuits and standard integrated circuits is provided comprising the steps of: a) designing the custom printed circuit from one or more functional blocks of electronic circuits and at least one or more standard integrated circuits; and b) direct printing one or more conductive traces between the one or more functional blocks of electronic circuits and the at least one or more standard integrated circuits to form the designed custom printed circuit.

According to the fourth aspect of the present invention, the step of direct printing comprises: a) ink jet printing the one or more conductive paths using an ink that comprises conductive particles in a solution; and b) curing the printed ink to create a path with a desired conductivity. The step of designing the custom printed circuit comprises: a) creating an interconnection pattern file to connect the one or more functional blocks of electronic circuits and the at least one or more standard integrated circuits from a library that defines the custom printed circuit in terms of the functional blocks; b) compiling the interconnection pattern file to create a direct printer readable interconnection file; and c) transmitting the direct printer readable interconnection file to the direct printer.

According to the fourth aspect of the present invention, the library is obtained from a computer assisted engineering (CAE) software tool, and the direct printer device comprises: an ink jet printer.

According to the fourth aspect of the present invention, the step of designing the custom printed circuit comprises: a) creating an interconnection pattern file to connect the one or more functional blocks of electronic circuits and the at least one or more standard integrated circuits from a design tool that defines the custom printed circuit in terms of the functional blocks; b) compiling the interconnection pattern file to create a direct printer readable interconnection file; and c) transmitting the direct printer readable interconnection file to the direct printer.

According to the fourth aspect of the present invention, the design tool is obtained from a very high speed integrated circuit (VHSIC) hardware description language (VHDL) software tool, and the pre-provided functional blocks of electronic circuits are selected from the group consisting of transistors, resistors, capacitors, inductors, buffer circuits, transmitter and receiver circuits, input/output circuit devices, input/output terminals, memory circuits, line drivers, microprocessors, display devices, and sensor devices. The one or more pre-provided functional blocks of electronic devices comprises: a) an array of one or more transistors. The at least one or more standard integrated circuits comprises: a) one or more of a counter circuit, processor circuit, timer circuit, logic circuits, sensor circuits, display circuits, and input/output circuits.

According to the fourth aspect of the present invention, the process further comprises a) providing a substrate with one or more transistors that have been direct printed on the substrate, and the step of providing a substrate with one or more transistors that have been direct printed on the substrate comprises: a) ink jet printing an array of transistors. The pre-provided functional blocks of electronic circuits comprises: a) an e-ink media with flexible substrate with an array of transistors, and the pre-provided functional blocks of electronic circuits comprises: a) a flexible substrate with an array of transistors provided in a fusible read-only memory (ROM) configuration.

According to the fourth aspect of the present invention, the custom printed circuit comprises: a display device, display driver device or a read-only memory (ROM) device, the substrate comprises a flexible, substantially non-rigid substrate or a substantially non-flexible, substantially rigid substrate.

According to a fifth aspect of the present invention, a process for creating a membrane keyboard device from a plurality of substrates, wherein each substrate comprises a pre-provided array of transistors and at least one or more standard integrated circuit is provided, comprising the steps of: a) direct printing a plurality of conductive traces for a first membrane of the membrane keyboard onto a first substrate, and direct printing a second plurality of conductive traces for a second membrane of the membrane keyboard onto a second substrate; and b) direct printing one or more conductive traces from either or both of one or more transistors from the array of transistors and one or more of the standard integrated circuits to at least one or more of the plurality of traces printed on the first and second membranes.

According to the fifth aspect of the present invention, the step of direct printing the conductive traces comprises: a) ink jet printing the conductive traces using an ink that comprises conductive particles in a solution; and b) curing the printed ink to create a trace with a desired conductivity.

According to a sixth aspect of the present invention, a computer readable medium containing a computer program is provided for creating a custom printed circuit on a pre-provided substrate with one or more electronic devices, wherein each electronic device comprises a plurality of terminals, each of the plurality of terminals electrically connected to at least one or more terminal pads, wherein the computer program performs the steps of: a) causing a direct printer to print one or more conductive paths between the plurality of terminal pads to create one or more custom printed circuits; b) defining one or more interconnection paths between the one or more terminal pads of the one or more electronic devices, wherein such interconnection paths defines a custom printed circuit with an electronic function; c) generating a series of commands to create the one or more interconnection paths for use with a direct printer device; and d) transmitting the series of commands to the direct printer device.

According to the sixth aspect of the present invention, the step of defining one or more interconnection paths between the one or more terminal pads of the one or more electronic devices comprises: a) designing the custom printed circuit from a library that defines the custom printed circuit in terms of the one or more electronic devices provided on the substrate; and b) generating a file comprising the one or more interconnection paths between the one or more terminal pads of the one or more electronic devices from the library that defines the custom printed circuit in terms of the one or more electronic devices provided on the substrate.

According to the sixth aspect of the present invention, the step of defining one or more interconnection paths between the one or more terminal pads of the one or more electronic devices comprises: a) utilizing a design tool that defines the custom printed circuit in terms of the one or more electronic devices provided on the substrate; and b) generating a file comprising the one or more interconnection paths between the one or more terminal pads of the one or more electronic devices from the design tool that defines the custom printed circuit in terms of the one or more electronic devices provided on the substrate.

According to the sixth aspect of the present invention, the step of generating a file comprises: a) compiling the file generated by the library comprising the one or more interconnection paths between the one or more terminal pads of the one or more electronic devices into a file that can be read by the direct printer device.

According to a seventh aspect of the present invention, a computer readable medium containing a computer program is provided for creating a custom printed circuit from pre-provided functional blocks of electronic circuits on a substrate, wherein the computer program performs the steps of: a) designing the custom printed circuit from one or more functional blocks of electronic circuits; and b) causing a direct printer to print one or more conductive traces between the one or more functional blocks of electronic circuits to form the designed custom printed circuit.

According to the seventh aspect of the present invention, the step of designing the custom printed circuit comprises: a) creating an interconnection pattern file to connect the one or more functional blocks of electronic circuits from a library that defines the custom printed circuit in terms of the functional blocks; b) compiling the interconnection pattern file to create a direct printer readable interconnection file; and c) transmitting the direct printer readable interconnection file to the direct printer.

According to the seventh aspect of the present invention, the step of designing the custom printed circuit comprises: a) creating an interconnection pattern file to connect the one or more functional blocks of electronic circuits from a design tool that defines the custom printed circuit in terms of the functional blocks; b) compiling the interconnection pattern file to create a direct printer readable interconnection file; and c) transmitting the direct printer readable interconnection file to the direct printer.

According to an eighth aspect of the present invention, a computer-readable medium containing a computer program is provided for providing user defined data in a configurable read-only memory device (ROM), wherein the ROM comprises an array of transistors on a substrate, the substrate also further comprising one or more functional blocks of electronic circuits, wherein the computer program performs the steps of: a) causing a direct printer to print a first interconnect pattern within the array of transistors to provide the user defined data; and b) causing a direct printer to print a second interconnect pattern to provide external and/or internal access to the user defined data.

According to the eighth aspect of the present invention, the step of causing a direct printer to print a first interconnect pattern comprises: a) causing a direct printer to print a first conductive path between a first group of conductive pads associated with a first group of transistors in the array of transistors where a high logic level is desired; and b) causing a direct printer to not print a conductive path between a second group of conductive pads associated with a second group of transistors in the array of transistors where a low logic level is desired.

According to the eighth aspect of the present invention, the computer program further performs the steps of a) designing a custom printed circuit from one or more functional blocks of electronic circuits and the ROM; and b) causing a direct printer to print one or more conductive traces between one or more functional blocks of electronic circuits to form the designed custom printed circuit.

According to the eighth aspect of the present invention, the step of designing the custom printed circuit comprises: a) creating an interconnection pattern file to connect the one or more functional blocks of electronic circuits and the ROM from a library that defines the custom printed circuit in terms of the functional blocks; b) compiling the interconnection pattern file to create a direct printer readable interconnection file; and c) transmitting the direct printer readable interconnection file to the direct printer.

According to the eighth aspect of the present invention, the step of designing the custom printed circuit comprises: a) creating an interconnection pattern file to connect the one or more functional blocks of electronic circuits and the ROM from a design tool that defines the custom printed circuit in terms of the functional blocks; b) compiling the interconnection pattern file to create a direct printer readable interconnection file; and c) transmitting the direct printer readable interconnection file to the direct printer.

According to a ninth aspect of the present invention, a computer-readable medium containing a computer program is provided for creating a custom printed circuit from pre-provided functional blocks of electronic circuits and standard integrated circuits, wherein the computer program performs the steps of: a) designing the custom printed circuit from one or more functional blocks of electronic circuits and at least one or more standard integrated circuits; and b) causing a direct printer to print one or more conductive traces between the one or more functional blocks of electronic circuits and the at least one or more standard integrated circuits to form the designed custom printed circuit.

According to the ninth aspect of the present invention, the step of designing the custom printed circuit comprises: a) creating an interconnection pattern file to connect the one or more functional blocks of electronic circuits and the at least one or more standard integrated circuits from a library that defines the custom printed circuit in terms of the functional blocks; b) compiling the interconnection pattern file to create a direct printer readable interconnection file; and c) transmitting the direct printer readable interconnection file to the direct printer.

According to the ninth aspect of the present invention, the step of designing the custom printed circuit comprises: a) creating an interconnection pattern file to connect the one or more functional blocks of electronic circuits and the at least one or more standard integrated circuits from a design tool that defines the custom printed circuit in terms of the functional blocks; b) compiling the interconnection pattern file to create a direct printer readable interconnection file; and c) transmitting the direct printer readable interconnection file to the direct printer.

According to a tenth aspect of the present invention, a computer-readable medium containing a computer program is provided for creating a membrane keyboard device from a plurality of substrates, wherein each substrate comprises a pre-provided array of transistors and at least one or more standard integrated circuits, wherein the computer program performs the steps of: a) causing a direct printer to print a plurality of conductive traces for a first membrane of the membrane keyboard onto a first substrate, and direct printing a second plurality of conductive traces for a second membrane of the membrane keyboard onto a second substrate; and b) causing a direct printer to print one or more conductive traces from either or both of one or more transistors from the array of transistors and one or more of the standard integrated circuits to at least one or more of the plurality of traces printed on the first and second membranes.

According to an eleventh aspect of the present invention, a system is provided for creating a custom printed circuit on a pre-provided substrate with one or more electronic devices, wherein each electronic device comprises a plurality of terminals, each of the plurality of terminals electrically connected to at least one or more terminal pads, comprising: a direct printer device configured to print one or more conductive paths between the plurality of terminal pads to create one or more custom printed circuits; wherein the one or more conductive paths comprise one or more interconnection paths between the one or more terminal pads of the one or more electronic devices, wherein such interconnection paths defines a custom printed circuit with an electronic function; a processor configured to generate a series of commands to create the one or more interconnection paths for use with a direct printer device and further configured to transmit the series of commands to the direct printer device.

According to the eleventh aspect of the present invention, the one or more interconnection paths between the one or more terminal pads of the one or more electronic devices are generated by the processor further configured to design the custom printed circuit from a library that defines the custom printed circuit in terms of the one or more electronic devices provided on the substrate; and wherein, the processor is still further configured to generate a file comprising the one or more interconnection paths between the one or more terminal pads of the one or more electronic devices from the library that defines the custom printed circuit in terms of the one or more electronic devices provided on the substrate.

According to the eleventh aspect of the present invention, the one or more interconnection paths between the one or more terminal pads of the one or more electronic devices are generated by the processor further configured to utilize a design tool that defines the custom printed circuit in terms of the one or more electronic devices provided on the substrate; and wherein the processor is still further configured to generate a file comprising the one or more interconnection paths between the one or more terminal pads of the one or more electronic devices from the design tool that defines the custom printed circuit in terms of the one or more electronic devices provided on the substrate.

According to the eleventh aspect of the present invention, the processor is further configured to compile the file generated by the library comprising the one or more interconnection paths between the one or more terminal pads of the one or more electronic devices into a file that can be read by the direct printer device.

According to a twelfth aspect of the present invention, a system is provided for creating a custom printed circuit from pre-provided functional blocks of electronic circuits on a substrate, comprising: a processor configured to design the custom printed circuit from one or more functional blocks of electronic circuits; and a direct printer device configured to print one or more conductive traces between the one or more functional blocks of electronic circuits to form the designed custom printed circuit.

According to the twelfth aspect of the present invention, the processor is further configured to create an interconnection pattern file to connect the one or more functional blocks of electronic circuits from a library that defines the custom printed circuit in terms of the functional blocks; compile the interconnection pattern file to create a direct printer readable interconnection file; and transmit the direct printer readable interconnection file to the direct printer.

According to the twelfth aspect of the present invention, the system according to claim 5, wherein the processor is further configured to create an interconnection pattern file to connect the one or more functional blocks of electronic circuits from a design tool that defines the custom printed circuit in terms of the functional blocks; compile the interconnection pattern file to create a direct printer readable interconnection file; and transmit the direct printer readable interconnection file to the direct printer device.

According to a thirteenth aspect of the present invention, a system is provided for providing user defined data in a configurable read-only memory device (ROM), wherein the ROM comprises an array of transistors on a substrate, the substrate also further comprising one or more functional blocks of electronic circuits, the system comprising: a direct printer device configured to print a first interconnect pattern within the array of transistors to provide the user defined data, to print a second interconnect pattern to provide external and/or internal access to the user defined data.

According to the thirteenth aspect of the present invention, the direct printer device is further configured to print a first conductive path between a first group of conductive pads associated with a first group of transistors in the array of transistors where a high logic level is desired; and to not print a conductive path between a second group of conductive pads associated with a second group of transistors in the array of transistors where a low logic level is desired.

According to the thirteenth aspect of the present invention, system further comprises: a processor configured to design a custom printed circuit from one or more functional blocks of electronic circuits and the ROM; and cause the direct printer device to print one or more conductive traces between one or more functional blocks of electronic circuits to form the designed custom printed circuit.

According to the thirteenth aspect of the present invention, the processor is further configured to create an interconnection pattern file to connect the one or more functional blocks of electronic circuits and the ROM from a library that defines the custom printed circuit in terms of the functional blocks; compile the interconnection pattern file to create a direct printer readable interconnection file; and transmit the direct printer readable interconnection file to the direct printer device.

According to the thirteenth aspect of the present invention, the processor is further configured to create an interconnection pattern file to connect the one or more functional blocks of electronic circuits and the ROM from a design tool that defines the custom printed circuit in terms of the functional blocks; compile the interconnection pattern file to create a direct printer readable interconnection file; and transmit the direct printer readable interconnection file to the direct printer device.

According to a fourteenth aspect of the present invention, a system is provided for creating a custom printed circuit from pre-provided functional blocks of electronic circuits and standard integrated circuits, comprising: a processor configured to design the custom printed circuit from one or more functional blocks of electronic circuits and at least one or more standard integrated circuits; and a direct printer device to print one or more conductive traces between the one or more functional blocks of electronic circuits and the at least one or more standard integrated circuits to form the designed custom printed circuit.

According to the fourteenth aspect of the present invention, the processor is further configured to create an interconnection pattern file to connect the one or more functional blocks of electronic circuits and the at least one or more standard integrated circuits from a library that defines the custom printed circuit in terms of the functional blocks; compile the interconnection pattern file to create a direct printer readable interconnection file; and transmit the direct printer readable interconnection file to the direct printer device.

According to the fourteenth aspect of the present invention, the processor is further configured to create an interconnection pattern file to connect the one or more functional blocks of electronic circuits and the at least one or more standard integrated circuits from a design tool that defines the custom printed circuit in terms of the functional blocks; compile the interconnection pattern file to create a direct printer readable interconnection file; and transmit the direct printer readable interconnection file to the direct printer device.

According to a fifteenth aspect of the present invention, a system is provided for creating a membrane keyboard device from a plurality of substrates, wherein each substrate comprises a pre-provided array of transistors and at least one or more standard integrated circuits, comprising: a direct printer device configured to print a plurality of conductive traces for a first membrane of the membrane keyboard onto a first substrate, and direct printing a second plurality of conductive traces for a second membrane of the membrane keyboard onto a second substrate; and wherein the direct printer is further configured to print one or more conductive traces from either or both of one or more transistors from the array of transistors and one or more of the standard integrated circuits to at least one or more of the plurality of traces printed on the first and second membranes.

According to a sixteenth aspect of the present invention, a system is provided for creating a custom printed circuit on a pre-provided substrate with one or more electronic devices, wherein each electronic device comprises a plurality of terminals, each of the plurality of terminals electrically connected to at least one or more terminal pads, comprising: means for causing a direct printer to print one or more conductive paths between the plurality of terminal pads to create one or more custom printed circuits; means for defining one or more interconnection paths between the one or more terminal pads of the one or more electronic devices, wherein such interconnection paths defines a custom printed circuit with an electronic function; means for generating a series of commands to create the one or more interconnection paths for use with a direct printer device; and means transmitting the series of commands to the direct printer device.

According to the sixteenth aspect of the present invention, the means for defining one or more interconnection paths between the one or more terminal pads of the one or more electronic devices comprises: means for designing the custom printed circuit from a library that defines the custom printed circuit in terms of the one or more electronic devices provided on the substrate; and means for generating a file comprising the one or more interconnection paths between the one or more terminal pads of the one or more electronic devices from the library that defines the custom printed circuit in terms of the one or more electronic devices provided on the substrate.

According to the sixteenth aspect of the present invention, the means for defining one or more interconnection paths between the one or more terminal pads of the one or more electronic devices comprises: means for utilizing a design tool that defines the custom printed circuit in terms of the one or more electronic devices provided on the substrate; and means for generating a file comprising the one or more interconnection paths between the one or more terminal pads of the one or more electronic devices from the design tool that defines the custom printed circuit in terms of the one or more electronic devices provided on the substrate.

According to the sixteenth aspect of the present invention, the means for generating a file comprises: means for compiling the file generated by the library comprising the one or more interconnection paths between the one or more terminal pads of the one or more electronic devices into a file that can be read by the direct printer device.

According to a seventeenth aspect of the present invention, a system is provided for creating a custom printed circuit from pre-provided functional blocks of electronic circuits on a substrate, comprising: means for designing the custom printed circuit from one or more functional blocks of electronic circuits; and means for causing a direct printer to print one or more conductive traces between the one or more functional blocks of electronic circuits to form the designed custom printed circuit.

According to the seventeenth aspect of the present invention, the means for designing the custom printed circuit comprises: means for creating an interconnection pattern file to connect the one or more functional blocks of electronic circuits from a library that defines the custom printed circuit in terms of the functional blocks; means for compiling the interconnection pattern file to create a direct printer readable interconnection file; and means for transmitting the direct printer readable interconnection file to the direct printer.

According to the seventeenth aspect of the present invention, the means for designing the custom printed circuit comprises: means for creating an interconnection pattern file to connect the one or more functional blocks of electronic circuits from a design tool that defines the custom printed circuit in terms of the functional blocks; means for compiling the interconnection pattern file to create a direct printer readable interconnection file; and means for transmitting the direct printer readable interconnection file to the direct printer.

According to an eighteenth aspect of the present invention, a system is provided for providing user defined data in a configurable read-only memory device (ROM), wherein the ROM comprises an array of transistors on a substrate, the substrate also further comprising one or more functional blocks of electronic circuits, comprising: means for causing a direct printer to print a first interconnect pattern within the array of transistors to provide the user defined data; and means for causing a direct printer to print a second interconnect pattern to provide external and/or internal access to the user defined data.

According to the eighteenth aspect of the present invention, the means for causing a direct printer to print a first interconnect pattern comprises: means for causing a direct printer to print a first conductive path between a first group of conductive pads associated with a first group of transistors in the array of transistors where a high logic level is desired; and means for causing a direct printer to not print a conductive path between a second group of conductive pads associated with a second group of transistors in the array of transistors where a low logic level is desired.

According to the eighteenth aspect of the present invention, the system further comprises means for designing a custom printed circuit from one or more functional blocks of electronic circuits and the ROM; and means for causing a direct printer to print one or more conductive traces between one or more functional blocks of electronic circuits to form the designed custom printed circuit.

According to the eighteenth aspect of the present invention, the means for designing the custom printed circuit comprises: means for creating an interconnection pattern file to connect the one or more functional blocks of electronic circuits and the ROM from a library that defines the custom printed circuit in terms of the functional blocks; means for compiling the interconnection pattern file to create a direct printer readable interconnection file; and means for transmitting the direct printer readable interconnection file to the direct printer.

According to the eighteenth aspect of the present invention, the means for designing the custom printed circuit comprises: means for creating an interconnection pattern file to connect the one or more functional blocks of electronic circuits and the ROM from a design tool that defines the custom printed circuit in terms of the functional blocks; means for compiling the interconnection pattern file to create a direct printer readable interconnection file; and means for transmitting the direct printer readable interconnection file to the direct printer.

According to a nineteenth aspect of the present invention, a system is provided for creating a custom printed circuit from pre-provided functional blocks of electronic circuits and standard integrated circuits, comprising: means for designing the custom printed circuit from one or more functional blocks of electronic circuits and at least one or more standard integrated circuits; and means for causing a direct printer to print one or more conductive traces between the one or more functional blocks of electronic circuits and the at least one or more standard integrated circuits to form the designed custom printed circuit.

According to the nineteenth aspect of the present invention, the means for designing the custom printed circuit comprises: means for creating an interconnection pattern file to connect the one or more functional blocks of electronic circuits and the at least one or more standard integrated circuits from a library that defines the custom printed circuit in terms of the functional blocks; means for compiling the interconnection pattern file to create a direct printer readable interconnection file; and means for transmitting the direct printer readable interconnection file to the direct printer.

According to the nineteenth aspect of the present invention, the means for designing the custom printed circuit comprises: means for creating an interconnection pattern file to connect the one or more functional blocks of electronic circuits and the at least one or more standard integrated circuits from a design tool that defines the custom printed circuit in terms of the functional blocks; means for compiling the interconnection pattern file to create a direct printer readable interconnection file; and means for transmitting the direct printer readable interconnection file to the direct printer.

According to twentieth aspect of the present invention, a system is provided for creating a membrane keyboard device from a plurality of substrates, wherein each substrate comprises a pre-provided array of transistors and at least one or more standard integrated circuits, comprising: means for causing a direct printer to print a plurality of conductive traces for a first membrane of the membrane keyboard onto a first substrate, and direct printing a second plurality of conductive traces for a second membrane of the membrane keyboard onto a second substrate; and means for causing a direct printer to print one or more conductive traces from either or both of one or more transistors from the array of transistors and one or more of the standard integrated circuits to at least one or more of the plurality of traces printed on the first and second membranes.

### BRIEF DESCRIPTION OF THE DRAWINGS

The novel features and advantages of the present invention will best be understood by reference to the detailed description of the preferred embodiments which follows, when read in conjunction with the accompanying drawings, in which:

FIG. 1 illustrates a block diagram of a direct printing system that can be used for manufacturing application specific printable circuits according to an embodiment of the present invention;

FIG. 2 illustrates a top view of a custom printed circuit board manufactured according to an embodiment of the present invention;

FIG. 3A illustrates a top view of another custom printed circuit board manufactured according to an embodiment of the present invention;

FIGS. 3B-3D illustrate schematics of different types of electronic devices that can be included in the custom printed circuit board shown in FIG. 3A;

FIGS. 4A-4C illustrate circuit schematic symbols of the electronic devices shown in FIGS. 3B-3D, respectively;

FIG. 5 illustrate a flow diagram of a process for manufacturing custom printed circuits according to an embodiment of the present invention;

FIG. 6 illustrates a side view of several interconnections and insulating layers provided in and around one pre-printed transistor device on the custom printed circuit shown in FIG. 2;

FIG. 7 illustrates a transistor that can be pre-provided on a substrate according to an embodiment of the present invention;

FIG. 8 illustrates a membrane keyboard assembly manufactured in part using the direct printing system shown in FIG. 1

FIGS. 9A-9C illustrate several components pieces of the membrane keyboard assembly shown in FIG. 8;

FIG. 10 illustrates a top view of a substrate pre-provided with pre-printed functional blocks of electronic devices and other pre-printed electronic devices for use with the direct printing system shown in FIG. 1, and the process described in reference to FIG. 11;

FIG. 11 illustrates a flow diagram of an alternative process for manufacturing custom printed circuits according to an embodiment of the present invention; and

FIG. 12 illustrates a flow diagram of a process for creating a programmable read-only memory custom printed circuit board according to an embodiment of the present invention.

### DETAILED DESCRIPTION OF THE PREFERRED EMBODIMENTS

The various features of the preferred embodiment(s) will now be described with reference to the drawing figures, in which like parts are identified with the same reference characters. The following description of the presently contemplated best mode of practicing the invention is not to be taken in a limiting sense, but is provided merely for the purpose of describing the general principles of the invention. This application is also related to co-pending U.S. Non-provisional Patent Application Ser. No. <___>, filed on Jan. 13, 2006, entitled “A System and Process for Manufacturing Custom Electronics by Combining Traditional Electronics with Printable Electronics,” by Chuck Edwards.

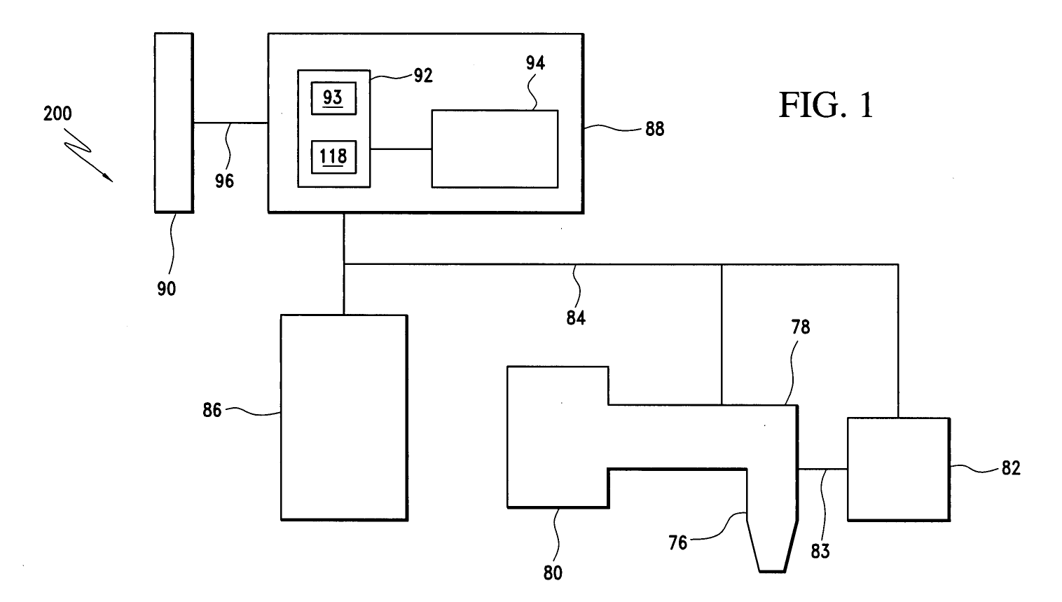

FIG. 1 illustrates a block diagram of a direct printing system 200 that can be used to manufacture application specific printable circuits (ASPC's) according to an embodiment of the present invention. Many different types of direct printing processes can be used to manufacture ASPC's or custom circuit boards. Such direct printing processes can include standard lithographic offset printing, flexography printing, laser printing, screen mesh printing, gravure printing, inkjet printing, among others. The discussion herein of the direct printing system 200 is but one exemplary embodiment, and included for purposes of illustration only. The systems and processes according to an embodiment of the present invention are not to be construed to be limited to the exemplary embodiment of the direct printing system 200, as one skilled in the art can appreciate. Furthermore, those of ordinary skill in the art can appreciate that the system and process according to the embodiments of the present invention need not be incorporated in one external direct printing device 200. The system and process of the present invention can be distributed among two or more printing and/or processing devices, including distributed networks (i.e., LAN, WAN, the Internet, among others).

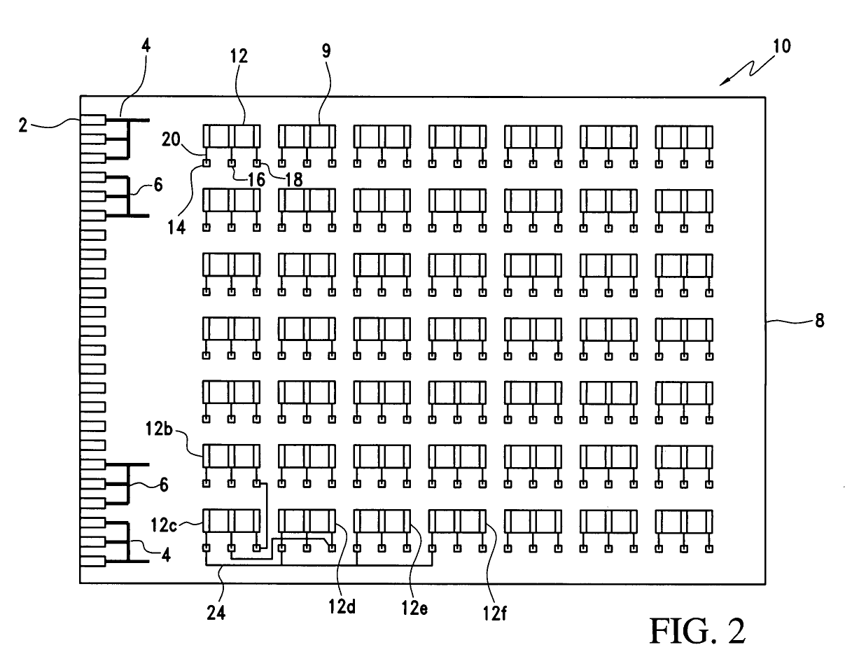

In FIG. 1, motor and drive assembly 82 receives commands from processor board 88 that places the print head 78 at expected print positions according to the print data file 118 received by the processor board 88. The motor and drive assembly 82 receives data and commands via bus 84 from processor 94, and locates the print head 78 with the use of either a belt system 83, a gear system, or any other type of mechanical apparatus for precisely locating the print head 78. As part of the.print head 78, there is a nozzle 76 and ink reservoir 80. A laser interferometer 86, or other type of distance measuring device, can be located substantially adjacent to the print head 78 for measuring the height of the print head 78 above the surface of the substrate 8 (shown in FIG. 2). Use of the laser interferometer 86 is not necessary for manufacturing ASPC's and custom circuits according to an embodiment of the present invention, and is included only for purposes of illustration, and not in a limiting manner, as one skilled in the art of the present invention can appreciate. Other components of the direct printing system 200 according to an embodiment of the present invention include the bus (data and command) 84, memory 92, an input/output (I/O) connector 90, and a second data/command bus 96 connecting the I/O connector 90 and the processor board 88. The processor board 88 receives all or some of a print data file 118, after it has been compiled, from an external source, which is then processed by the processor 94 to create printing commands. Conventional printing systems are well known to those of ordinary skill in the art, and the direct printing system 200 according to an embodiment of the present invention performs similarly to the conventional systems in receiving data and commands from an external source thereof. Operations relating to receipt of the print data file 118 from the external source will not be repeated here for purposes of brevity and clarity, as it is presumed that those skilled in the art of the present invention understand such operations. Examples of such direct printing systems 200 include ink jet printers, laser printers (xerographic printing), screen mesh printers, lithographic offset printers, flexography printers, and gravure printers, among others.

As illustrated in FIG. 1, processor board 88 comprises processor 94 which can be one or more general or special purpose processors, and memory 92, which itself comprises printing software 93. Memory 92 can comprise an input buffer, printing software 93, and an output buffer. It should be noted that in this exemplary embodiment of the present invention, a database, which is not shown, can be a separate hardware memory item, though that need not always be the case. The database can also be implemented as a portion of the memory 92. The database can contain any stored information that memory 92 can store, including print data file 118, printing software 93, and/or other information.

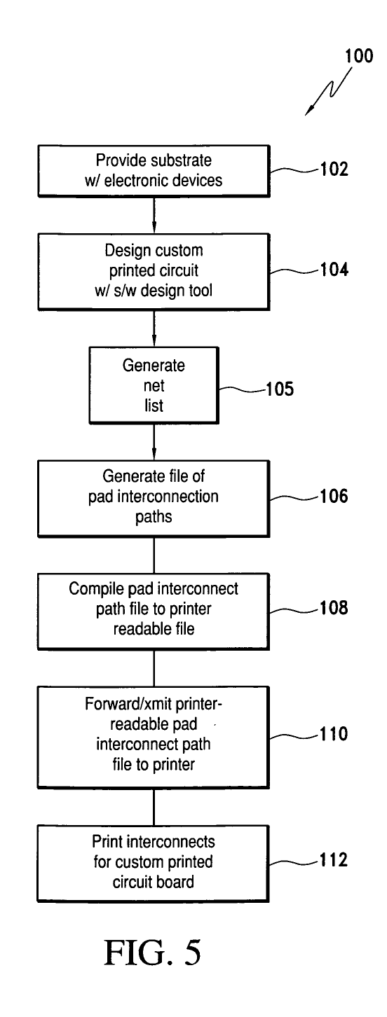

Printing software 93 comprises one or more computer programs that can be stored on any type of computer readable medium or other data storage devices. These additional data storage devices can include removable and/or non-removable devices, such as, for example, magnetic disks, optical disks, or tape. Computer readable medium can include volatile and nonvolatile, removable and non-removable medium implemented in any method or technology for storage of information, such as computer readable instructions, data structures, program modules, or other data. Computer readable medium can include, by way of a non-limiting example, random access memory (RAM), read-only memory (ROM), electrically erasable programmable ROM (EEPROM), computer disk ROMs (CD-ROMS), digital versatile disks (DVDs), magnetic tape, flash memory, bubble memory devices, optical storage devices, floppy disks, hard drives, and any other type of memory storage devices (e.g., memory sticks, micro-cassettes, among other types of devices). As discussed in greater detail below, the various embodiments of the present invention comprise one or more methods, as shown and described in reference to FIGS. 5, 11, and 12. Each and all of these methods can be embodied as printing software 93. Printing software 93 accepts print data file 118 and processes it according to a particular embodiment of the present invention to print on non-uniform substrates. According to an exemplary embodiment of the present invention, printing software 93 accepts print data file 118 to print interconnects on a substrate that can be pre-provided with electronic devices. According to another exemplary embodiment of the present invention, printing software 93 accepts print data file 118 to print interconnects on a substrate that can be pre-provided with functional blocks of electrical devices. According to a further exemplary embodiment of the present invention, printing software 93 accepts print data file 118 to direct print interconnect paths on a substrate that can be pre-provided with an array of programmable read-only memory transistors and other electronic devices.

Any and all components of the direct printing system 200, shown and discussed in regard to FIG. 1, including, but not limited to I/O connector 90, processor 94, memory 92, laser interferometer 86, print head 78, and motor and drive assembly 82 (among other components), can be any suitable type of electrical or electronic device capable of performing the functions for direct printing system 200 and its components as discussed herein. For example, direct printing system 200 can comprise hardware, software, firmware or any suitable combination thereof.

Alternatively, direct printing system 200, and any and all components thereof, including, but not limited to, processor 94, laser interferometer 86, print head 78, and motor and drive assembly 82 (among other components), can be comprised of any suitable type of processor, including any type of microprocessor, microcontroller, digital signal processor (DSP), application-specific integrated circuit (ASIC), programmable read-only memory (PROM), erasable programmable read-only memory (EPROM), electrically-erasable programmable read-only memory (EEPROM), or the like. The direct printing system 200, and any and all components thereof, including, but not limited to, processor 94, and memory 92, laser interferometer 86, print head 78, and motor and drive assembly 82 (among other components), can be connected to or include a memory, such as, for example, any type of computer memory or any other type of electronic storage medium, such as, for example, read-only memory (ROM), random access memory (RAM), cache memory, compact disc read-only memory (CDROM), electro-optical memory, magneto-optical memory, or the like. The processor and memory can be used, for example, to perform some or all of the functions of the direct printing system 200, and any and all components thereof, including, but not limited to, processor 94, and memory 92, laser interferometer 86, print head 78, and motor and drive assembly 82 (among other components), described herein. As will be appreciated based on the foregoing description, the memory can be programmed using conventional techniques known to those having ordinary skill in the art of computer programming. For example, the actual source code or object code of the computer program can be stored in the memory 92.

Further still, as one of ordinary skill in the art can appreciate, printing software 93 does not necessarily need to reside in memory 92. Or, alternatively, only part of printing software 93 can reside in memory 92. Printing software 93 can reside in any of the type of memory 92 as discussed above in greater detail that is associated with a computer (e.g., laptop, desk set, server, workstation, among others) that communicates with direct printing system 200. In this way, then, the computer (not shown) becomes part of direct printing system 200, along with any network that the computer might use as a means of communications with direct printing system 200 (including, for example, a local area network, wide area network, the internet, a WiFi system, Bluetooth, among others) and that is connected to the computer and direct printing system 200.

As discussed briefly above, the laser interferometer 86 measures the distance from the print head 78 to the surface of the substrate 8. The details of how the direct printing system 200 uses such height data in direct printing onto the substrate 8 are not necessary for understanding the embodiments of the present invention disclosed herein. A discussion of the operation and use of the laser interferometer 86, however, can be found in co-pending U.S. Non-provisional Patent Application Ser. No <___>, entitled “Printable Electronic Features on Non-Uniform Substrate and Processes for Making Same,” by Karel van Heusden, et al., filed on Jan. 13, 2006.

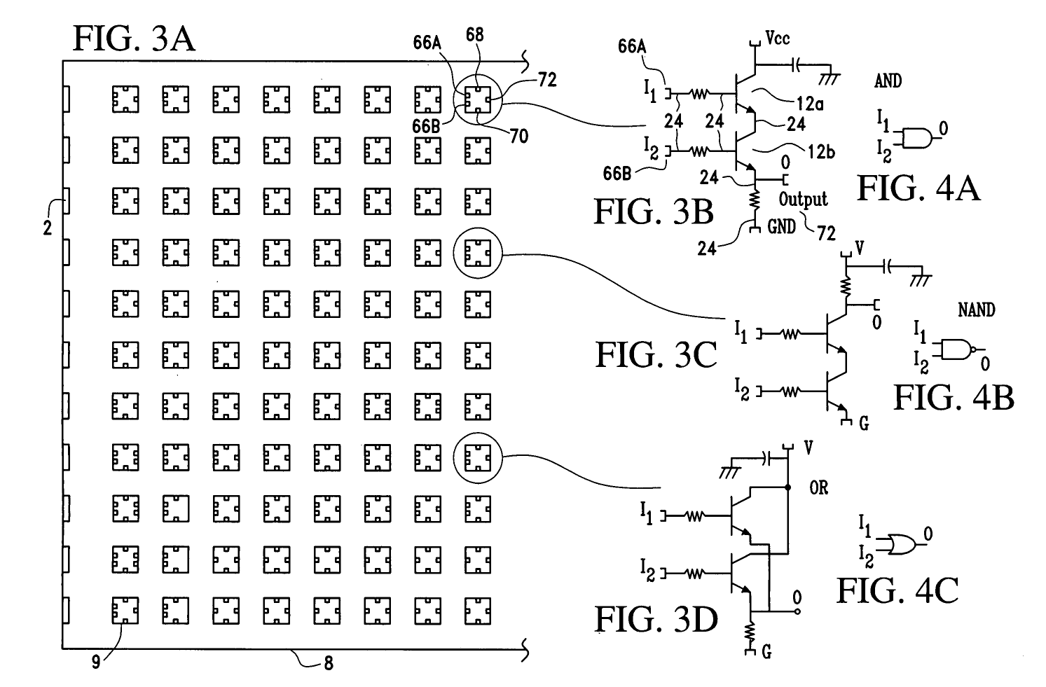

FIG. 2 illustrates a top view of a custom printed circuit board 10, comprising a substrate 8 with pre-printed electronic circuits. The custom printed circuit board 10 shown in FIG. 2 can be created by the direct printing system 200 and process 100 discussed in reference to FIG. 3. Alternatively, the custom printed circuit board 10 can be manufactured using several different types of printing systems and processes for printing conductive traces, as well as some passive components. For example, traditional offset lithography printing can be used to manufacture the custom printed circuit 10 according to the processes described herein according to an embodiment of the present invention, as well as laser printing, inkjet printing, gravure printing, flexography printing, and screen mesh printing can be used to manufacture the custom printed circuit 10 according to the processes described herein according to an embodiment of the present invention. The custom printed circuit board 10, shown in FIG. 2, is an example of custom printed circuit boards that can be manufactured by the direct printing system 200 and process 100 according to an exemplary embodiment of the present invention. For purposes of this discussion, the exemplary custom printed circuit board 10 has been shown in a very simple form; generally, custom printed circuit boards will be much more complex, and filled with a significantly larger quantity of electronic devices, though this need not always be the case. The custom printed circuit board 10 should therefore not be considered in any manner to be a limiting example; it has been shown as thus in order to make the embodiments of the present invention easier to understand.

The custom printed circuit board 10 comprises a substrate 8 that is pre-provided with a plurality of different types of electronic devices, in various quantities. These electronic devices 9 include, but are not limited to, transistors, resistors, capacitors, inductors, diodes, photodiodes, light emitting diodes, buffer circuits, transmitter and receiver circuits, input/output circuit devices, logic gates, input/output terminals, memory circuits, line drivers, microprocessors, display devices, sensor devices, power supply devices such as super-capacitors, batteries, printed batteries, photovoltaic cells, and printed photovoltaic cells, and other suitable electronic and electrical devices. According to an embodiment of the present invention, the electronic devices 9 can be pre-provided in several different manners and forms. For example, the electronic devices 9 can be pre-printed by an identical direct printing system 200, or another type of direct printing system, that is capable of printing electronic devices 9 onto the substrate 8. In another embodiment of the present invention, the pre-provided electronic devices 9 can be provided on a traditional printed circuit board substrate with conventional integrated circuit packages, such single-in-line package (SIP), dual-in-line package (DIP), surface mount, and the like. These are well known to those of ordinary skill in the art. The substrates 8 that are pre-provided with electronic devices 9 can, in an exemplary embodiment of the present invention, be manufactured as a “base layer” component for customizers who then design custom circuits for other manufacturers or end users of the custom circuit board.

In the exemplary embodiment shown in FIG. 2, the electronic devices 9 comprises a plurality of transistors 12. Each transistor 12 has, for example, an emitter, base and collector, each of which are connected, respectively, to an emitter pad 14, base pad 16 and collector pad 18 by a conductive lead 20. In other exemplary embodiments, the transistors 12 can be pre-provided on the substrate 8 with certain groups of them already connected together to form minor electronic function devices. An example of simple electronic devices 9 that can be pre-provided on the substrate 8 are clocks, sensors, and logic gates. In an exemplary embodiment of the present invention, clocks, sensors and logic gates can be pre-provided on a flexible, substantially non-rigid substrate in the form of, for example, a pill dispensing device. Pill dispensing devices are commonly used in the medical industries (i.e., drug companies) to track drug usage for certain patients, especially those involved in drug efficacy trials. These pill dispensing devices can have circuitry to track when a patient takes the drug, and can allow the patient to provide some information related to the drug taking event. In an exemplary embodiment of the present invention, a substrate 8 can be manufactured with the above mentioned circuitry (logic gates, clocks, sensors) that tracks the pill taking event. The drug companies can then print on the pill dispensing device certain questions that will be associated with certain sensors, so that the data can be tracked. In another embodiment of the present invention, the drug companies can also print conductive traces according to the embodiments of the present invention described herein that allows them to customize the circuit design according to their needs.

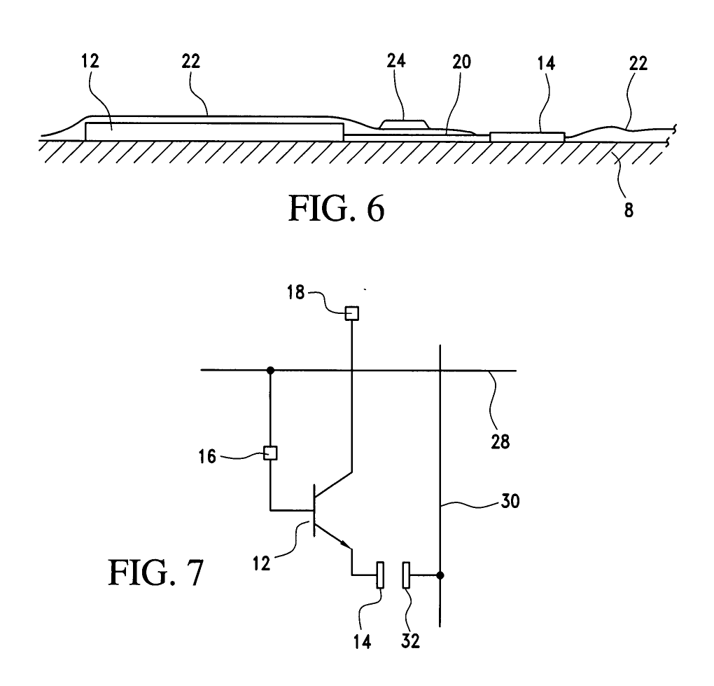

The substrate 8 with the plurality of electronic devices 9 can also include a plurality of pre-provided terminal connectors 2, which can also be direct printed on the substrate 8 or attached in a more conventional manner, depending upon the substrate material. In FIG. 2, the terminal connectors 2 are shown as being located on just one side of the substrate 8, but can actually be located anywhere, and even on an opposite side as the side the plurality of electronic devices 9 are located. In FIG. 2, several of the terminal connectors 2 are shown interconnected, for example, the first group comprises a power conductor 4 (of which there are two such interconnected groups) and the second group comprises a ground plane conductor 6 (of which there are also two such interconnected groups. The manner in which the two interconnected groups 4, 6 are shown in FIG. 2 is not a limiting example, as one of ordinary skill in the art of the present invention can appreciate. Indeed, as will be described in greater detail below, with the use of insulating layers 22 (shown and described in greater detail below in reference to FIG. 6), conductive traces 24 can be provided between any two or more terminal connectors 2 (or the connectors of other electronic devices) in virtually any layout imaginable.

The substrate 8 can be a flexible, substantially non-rigid substrate. Alternatively, the substrate 8 can be a non-flexible, substantially rigid substrate. The substrate 8 in this embodiment can be any of the substrate materials described herein. In one exemplary embodiment, the substrate 8 has opposing major planar surfaces. The types of substrates 8 that are particularly useful according to an embodiment of the present invention include polyfluorinated compounds, polyimides, epoxies (including glass-filled epoxy), polycarbonates and other polymers. Other useful low-cost substrates 8 include cellulose-based materials, such as wood, paper, cardboard, or other wood pulp based materials, acetate, polyester, such as PET or PEN, polyethylene, polypropylene, polyvinyl chloride, acrylonitrile, butadiene (ABS), flexible fiber board, non-woven polymeric fabric, cloth, metallic foil, silicon, and glass. In another embodiment of the present invention, the substrate 8 comprises a component selected from the group consisting of an organic substrate, a glass substrate, a ceramic substrate and a polymeric substrate. The substrate 8 can be coated, for example, with a dielectric on a metallic foil. Although the present invention can be used for such low-temperature substrates, it will be appreciated that traditional substrates such as ceramic substrates can also be used in accordance with embodiments of the present invention.

The processes of the present invention also enable the formation of conductive features onto non-planar substrates, such as curved substrates or substrates that have a stepped feature on the substrate surface. The conductive features can also be well adhered, such that a flexible substrate can be rolled or otherwise flexed without damaging the integrity of the conductive feature.

FIG. 3A illustrates a top view of a custom printed circuit board 8 with a plurality of pre-provided electronic devices 9 fabricated from a plurality of transistors, resistors and capacitors. As discussed above, the substrate 8 can be supplied to a user with pre-provided electronic devices 9. In an exemplary embodiment of the present invention shown and described in reference to FIG. 3A, these electronic devices 9 can include a plurality of transistors, resistors, and capacitors. As shown in FIGS. 3A-3D, a plurality of transistors, resistors and capacitors are pre-provided, but are now interconnected as logic gates and other types of electronic devices. For example, in FIG. 3A, there are several different types of electronic devices 9. Some of these electronic devices 9 are different logic gates that can be constructed from 2, 3, 4, or even more transistors 12. FIG. 3B is a greatly enlarged view of a logic gate. The logic gate, in this example, an AND gate, is made up of 2 transistors, three resistors and one capacitor, interconnected by conductive traces 24. The user of the design tool would not see the individual transistors 12, but instead only the circuit symbol of an AND gate, with two inputs 66a, 66b, and one output 72 (FIG. 4A). The individual logic gates in FIG. 3B are generally much smaller than the naked eye can discern. FIGS. 3C and 3D each show a NAND gate and an OR gate, respectively. FIGS. 4B and 4C each show the circuit schematic symbol that the user, when using the design tool, would see when designing the custom circuit. The first and second inputs for the logic gate, 11 and 12, are the first and second inputs to the electronic device 66a, 66b, and the output for the logic gate O2 is equivalent to the output of the electronic device 72. The user uses the design tool to draw interconnection paths among the logic gates, I/O circuits and connectors, and other types of electronic devices 9 that can be pre-provided on the substrate 8. All the conductive traces 24 shown in the enlarged views (i.e., FIG. 3B) are pre-provided by the manufacturer of the substrate 8. Although they are not shown in FIGS. 3B-3D, or 3A, the power lead to each electronic device 68 can be interconnected by conductive traces 24 and connected to one or more of the terminal connector pads by the manufacturer of the substrate 8. Similarly, the ground lead for each electronic device 70 can also be interconnected by conductive traces 24 and connected to one or more of the terminal connector pads by the manufacturer of the substrate 8.

Furthermore, as discussed above, all the transistors, resistors and capacitors, and even I/O connectors can be direct printed on the substrate 8 by the manufacturer of the substrate 8. The level of sophistication needed for the transistors will be a factor in determining which printing process to use in direct printing the transistors. More sophisticated transistors will require closer tolerances in printing that can be generally achieved by the lithographic offset printing process. Of course, all of the direct printing processes discussed herein are capable of direct printing transistors, but not all processes can print the transistors as small as lithographic offset printing, with the amount of detail it can. The user can use the design tool to draw interconnection paths between the individual logic gates, I/O connectors and other electronic devices 9 that can also be included on the substrate 8. The same or different printing process used to print the pre-provided electronic devices 9 (i.e., logic gates, among others) shown in FIG. 3A can be used to print the conductive paths, at the user's own facility. For example, the substrate 8 can be pre-provided with the transistors 12, resistors, capacitors and I/O connectors with lithographic offset printing technology, which allows very high resolution printing, thereby allowing the manufacturer of the substrate 8 to create larger quantities of transistors on a given substrate 8 size. These transistors can be grouped together to form specific electronic devices, as discussed above, such as the NAND gates. The user can also use lithographic offset printing if desired, even if only conductive traces 24, resistors, and capacitors are to be added. Alternatively, the user can use other types of direct printing processes depending on the ultimate use and cost of the custom printed circuit 10. Some of the other types of direct printing are less expensive than lithographic offset printing, but are also less precise than lithographic offset printing.

FIG. 5 illustrate a flow diagram of a process 100 for manufacturing a custom printed circuit board 10 according to an embodiment of the present invention. The process 100 begins with step 102, in which the substrate 8 with pre-printed electronic devices 9 is provided to a user of a direct printing system 200 that can create custom printed circuit boards 10 according to an embodiment of the present invention.

As discussed above, the substrate 8 is pre-provided with a plurality of electronic devices, and these electronic devices 9 can encompass many different types of well known electronic functions. In one exemplary embodiment of the present invention, the substrate 8 can be pre-provided with several thousand, even as many several tens or hundreds of thousands of transistors 12. Each transistor will have at least three connections: an emitter pad 14, a base pad 16 and a collector pad 18. The pads 14, 16 and 18 can be interconnected with conductive traces 24 provided by the direct printing system 200. The user of the direct printing system 200 can then use several different tools to create the interconnection patterns.

In step 104, the user of the direct printing system 200 designs the custom printed circuit board 10 using a software based electronic circuit design tool (design tool). The design tools available to the user of the direct printing system 200 include a combination of two or more conventional electronic circuit design tools, proprietary software designed for use on a particular embodiment of the direct printing system 200, or can be other well known software design tools for designing electronic circuits. Each type of design tool is well known to those of ordinary skill in the art of the present invention. Examples of well known software design tools for creating electronic circuits include a very high speed integrated circuit hardware description language (VHDL) software tool. Typically, the design tool can include at least three components: 1) a symbol library, which uses schematic symbols to design and draw a circuit using a CAD system; 2) circuit simulation software to simulate the performance of the designed circuit; and 3) a layout library, which translates the designed circuit into a layout for the electronic inks.

The design tools are multi-functional and versatile, and allow the user to create the custom printed circuit board 10 in several different ways. For example, the design tool can allow the user to design the custom printed circuit from a library that defines circuit device symbols for the custom printed circuit board 10 in terms of the one or more electronic devices 9 provided on the substrate, or utilize the design tool to define the custom printed circuit board 10 in terms of the one or more electronic devices 9 provided on the substrate. The library can be obtained from a computer assisted engineering software tool. The latter process shall be discussed first.

To use the design tool to define the custom printed circuit in terms of the one or more electronic devices 9 provided on the substrate, the user draws interconnection paths between user selected electronic devices. The user can also, in another exemplary embodiment of the present invention, design additional resistors and capacitors for use in the custom circuit. These passive devices can be direct printed using any of the direct printing processes described herein. This can be accomplished by picking-and-placing the electronic device in the design tool circuit board (i.e., in a virtual circuit board on a computer screen), and then drawing the interconnection paths between the electronic devices. As discussed in greater detail below, the design tool can show physically how the set of electronic devices 9 that create the custom printed circuit is laid out on the substrate 8, along with the interconnection paths. The set of interconnection paths between each electronic device on the substrate 8 creates circuits to perform specific electronic functions. For example, smaller groups of electronic devices 9 can interconnected to design a logic AND or NAND gate. Or, the user can create analog devices, such as amplifiers, current control circuits, among others. Since the electronic devices 9 provided on substrate 8 can also include resistors, capacitors and inductors, among other devices, the user can incorporate these passive components as well into the user's custom circuit design. An example of a physical layout is shown in FIG. 2, in which transistors 12a-12f have been selectively interconnected to provide a first circuit. The user continues to select and interconnect electronic devices 9 until the desired electronic function for the custom printed circuit board is achieved.

Following completion of the circuit design for the custom printed circuit board, a first circuit design verification and analysis tool can be used to verify that the circuit works as intended, and determine its operating characteristics. As one of ordinary skill in the art can appreciate, this can include bode plots, timing diagrams for digital circuitry, among others. A more sophisticated second circuit design verification and analysis tool can be used to test the circuit(s) of the custom printed circuit board after the design tool has created a layout of the custom printed circuit board 10, which is discussed in greater detail below. Of course, as one skilled in the art of the present invention can appreciate, the first and second verification and analysis tools can be the same or different tools.

To use the design tool to design the custom printed circuit from a library that defines the custom printed circuit in terms of the one or more electronic devices 9 provided on the substrate, the design tool provides circuit device symbols that represent various electronic circuit functions that can be fabricated with the electronic devices 9 provided on the substrate 8. For example, if the substrate 8 is provided with at least transistors, resistors, capacitors, and I/O connectors, the design tool can allocate a first amount of transistors, resistors and capacitors to form logic gates, analog amplifiers, driver and receiver circuitry, among other devices. The design tool will already have a pre-provided layout of the chosen logic gates and other electronic circuit functions. The design tool does not show the user this allocation of transistors and/or passive components: instead, the design tool provides the standard circuit device symbol, and the user draws the interconnection paths between the main terminals of the circuit device symbol (e.g., a NAND gate with two inputs and one output (the main terminals)). As the user selects each circuit device symbol, the amount and type of electronic devices 9 (e.g., for a logic gate, this represents a certain number of transistors and perhaps other components) that are needed to make the desired electronic circuit function are deducted from the pool of available electronic devices. Of course, the design tool can also provide circuit device symbols of the electronic devices 9 that have been provided on the substrate 8 (e.g., the transistors, resistors, and other electronic devices) and the user can selectively choose those electronic devices 9 individually if desired. An example of this might be to add a current limiting circuit made from several transistors or a diode from a single transistor.

The user continues to build the custom printed circuit board with circuit device symbols until the desired electronic function is achieved, or the substrate 8 is depleted of electronic devices. If the latter occurs, the user must redesign the custom printed circuit board realizing the practical constraints. Following completion of the circuit design for the custom printed circuit board 10, a first circuit design verification and analysis tool (analysis tool) can be used to verify that the circuit works as intended, and determine its operating characteristics (this is identical to the “circuit simulation software” discussed briefly above). As one of ordinary skill in the art can appreciate, this can include bode plots, timing diagrams of digital circuitry, among other design verification tools. A more sophisticated second circuit design verification and analysis tool can be used to test the circuit(s) of the custom printed circuit board after the design tool has created a layout of the custom printed circuit board, which is discussed in greater detail below. Of course, as one skilled in the art of the present invention can appreciate, the first and second verification and analysis tools can be the same or different tools. Virtually any electronic function can be designed onto the custom printed circuit board using either the library or libraries, or the electronic devices 9 themselves.

Once the user has designed the custom printed circuit board 10 to include one or more major electronic functions, the design tool creates a net list in step 105. Net lists are a simple list of interconnected points. For example, if a first pin on a first integrated circuit device (commonly referred to as “Un”; where “n” equals some number) is connected to a second pin on a second device and a second pin on a third device, the net list could look like this: U1(1)-U2(2)-U3(2), and so on. In step 106, the design tool then generates a file of pad interconnection paths (step 106 of process 100), based, in part, on the net list. The design tool can also display the pad interconnection paths on a screen or display for the user to view, and possible alter as desired. Changing the pad interconnection paths does not change the net list; however, changing the net list will necessarily change the pad interconnection paths.

Following the step of generating the pad interconnection paths, the design tool, with knowledge of the substrate 8 its collection of various types of electronic devices, and their physical geometries, will provide the most efficient set of pad interconnection paths possible, taking into account the direct printing system's 200 ability to lay insulating layers over conductive paths, or even electronic devices, to provide a shortest route possible between two (or more) pad interconnection points. The pad interconnection paths are created for both the circuit device (i.e., a logic gate fabricated from transistors, resistors, and/or capacitors), and the pad interconnect paths between the circuit devices (i.e., inputs to the NAND gate and its outputs). In addition, the design tool can take into account maximum heights, the different types of inks that can be used, impedances of the conductive paths, if necessary, power requirements, and many other factors. All this information can be taken into account to create the pad interconnection paths, which are then stored in a separate file, the pad interconnection file.

Following the generation of the pad interconnection file, the design tool can then run the second design verification and analysis tool (second analysis tool) . The second analysis tool performs a more sophisticated function at this point than the first analysis tool, as it takes into account the nature of the exact paths of interconnection between the electronic devices 9 on the particular pre-provided substrate 8. The second analysis tool takes into account the effect of crosstalk, differing impedances, interference from exterior sources, variances in the power supplies, and other factors. If the design of the custom printed circuit board does not work as intended, the design tool can recommend to the user to redesign certain portions of the design, or suggest alternative interconnection layouts itself. Once the design for the custom printed circuit board is completed, process 100 proceeds to step 108.

In step 108, the pad interconnection path file is compiled so that it is put into a format that the direct printer system 200 can understand. The type of direct printing system used will determine the format the compiled pad interconnection path file takes. In this sense, “compiled” means not only the traditional software or electronic sense of translating data from one form to another; it also means taking the pad interconnection path data and, in the case of a screen mesh printing system, flexography printing system, lithographic offset printing systems, and gravure printing system (i.e., the “physical direct printing systems”), generating a physical layout pattern that the physical direct printing systems can use to print on the substrate 8. The following discussion, however, will consider only the non-limiting exemplary embodiment of the present invention wherein the pad interconnection path data file is generated electronically, and will be used in either a laser or ink jet direct printing system. In this case, the printer driver software will transform the pad interconnection file into a format the direct printer system 200 can understand, the direct printer readable file.

The direct printer readable file provides a series of commands/data that the direct printer system 200 can use to actually print the interconnection paths on the pre-provided substrate 8. An equivalent function is performed in standard desktop personal computer printer driver software (driver software). Driver software transforms the data contained in (word processing) application program files into a format the attached inkjet, laser-jet or dot matrix printer can use. If a substrate 8 is placed in the direct printing system 200, the user forwards the direct printer readable file to the direct printing system 200 (step 110), which then prints the interconnection paths as provided (step 112).

As discussed above, the design tool can create interconnection paths that are maximized in terms of providing the shortest route possible between two or more pads or terminals on a circuit device. This provides the benefit of maximizing the use of the surface area of the substrate 8. This can, in some instances, allow greater circuit density, and/or smaller substrate size, saving money not only in the manufacture of the custom printed circuit, but if the custom printed circuit is being used in some device, possibly reducing its size as well (thereby providing additional savings). FIG. 6 illustrates a side view of several interconnections and insulating layers provided in and around one pre-printed transistor device on the custom printed circuit board 10 shown in FIG. 5. In FIG. 6, a transistor 12 is shown with a first conductive trace 20 between its emitter and an emitter pad 14. Then, an insulating layer 22 has been placed on top of the transistor 12 and the conductive trace 20, so that a second conductive trace 24 can be co-located over the conductive trace 20. Placing a conductive trace 24 over an insulating layer 22 in this manner can be done to provide the shortest possible path for a signal, or to provide power and/or ground planes. For example, once an entire custom printed circuit board 10 has been designed and all the interconnection paths provided, the direct printing system 200 according to an embodiment of the present invention can cover the entire custom printed circuit board 10 with an insulating layer 22 and then a ground plane layer (to minimize interference), and then cover the custom printed circuit board with another insulating layer 22 to keep dirt and moisture away from the conductive traces 20, 24 and electronic devices.

Custom printed circuit boards 10 with many different types of electronic functions can be manufactured using the direct printing system 200 and processes described herein according to the embodiments of the present invention. One particularly useful type of device is an radio frequency identification (RFID) tag. Conventional RFID tags suffer from at last two serious drawbacks. First, conventional RFID tags are not secure enough in that the data they contain can be easily re-written by unauthorized persons. Re-writing, in most cases, would simply be annoying and/or a waste of time. In an airline luggage handling facility, or cargo shipping areas, however, re-writing of the data on an RFID tag can create serious situations. For example, if an infiltrator rewrites an RFID tag so that the container it is attached to passes through security much easier than it should, the consequences could be potentially catastrophic. Another serious drawback in some RFID tags is that in order to use them, they must be designed with both write and read circuitry. The write circuitry on the RFID tag receives an RF signal from a transceiver responsible for putting data into the RFID tag (i.e., storing the data into the RFID tag). The write receiver receives the data and writes it to the memory component of the RFID tag. Typically, the write circuitry is complex, even if it is implemented in the form of a laser receiver. The write circuitry is then typically never used again. However, the write circuitry provides an access point for unauthorized persons to enter unauthorized data into the RFID tag. Thus, not only does it provide an access point for unauthorized persons, it is normally used only once. Eliminating its use increases security and decreases the cost of the device.

Of course, prior art methods for manufacturing RFID devices can also “hard-wire” the data into the RFID device, wherein the problem of unauthorized writing can be alleviated. One significant difference between the prior art and the process for manufacturing an RFID according to an embodiment of the present invention is the ability to make the RFID device a secure, less costly device at the point of use, as opposed to a remote location. The process according to the embodiment of the present invention is therefore much more cost effective, efficient, and convenient, than prior art systems.

The direct printing system 200 and processes according to the embodiments of the present invention can substantially prevent unauthorized re-writing of RFID tags, and decrease the cost of manufacturing and using the same. The direct printing system 200 can quickly create a secure RFID tag that cannot be re-written because the data contained within is “hard-wired” on the custom printed circuit board 10. In this case, the substrate 8 can be paper, which is easily and readily printable, and can be combined with the pre-provided RF portion of the circuitry readily. In the RFID tag according to an embodiment of the present invention, the secure information is printed on the custom printed circuit in the form of a programmable read-only memory (PROM).

FIG. 7 illustrates a transistor 12 that can be pre-provided on a substrate 8 according to an embodiment of the present invention. The transistor 12 in the configuration shown in FIG. 7 can be used to create a PROM according to an embodiment of the present invention. Conventional PROM's contain transistors that are provided in matrix form. In conventional PROM's, a fusible link exists between the emitter pad 14 and the fuse pad 32. If a fusible link was provided between the emitter pad 14 and the fuse pad 32, it would either be left intact or blown to create the required logic level “1” or “0” at that location (intact=“1”; open =“0” ). During the programming stage of the conventional PROM, all the appropriate “0” outputs are grounded. Then, each transistor 12 is turned on, and a current of a few tens of milli-amps flows through the fusible link, blowing it, creating the logic level “0”. In the programmable PROM according to an embodiment of the present invention, however, there is no fusible link, only an opening between the crossover point (the space between the emitter pad 14 and fuse pad 32). Thus, a logic level “0” is built into the PROM device, and to create a logic level “1” a conductive trace needs to be applied between emitter pad 14 and the fuse pad 32.

As discussed above, the design tool can provide the user with the means to apply a conductive trace to each desired logic level “1” location, or, more conveniently, the design tool can have an auxiliary tool that receives data (user defined data) that is then processed by the design tool to create all the desired logic level “1” locations. This auxiliary tool interfaces with the design tool to provide the data in a correct format that the design tool can read, and which the design tool can then translate into the logic level “1” positions in the PROM matrix.

A direct printing system 200 that can create a programmable PROM according to this embodiment of the present invention can be approximately the size of a cell phone, and print out RFID tags with data acquired from many different sources (e.g., an attached computer, integral or attached keyboard, among others). Many others uses exist for such programmable PROM devices manufactured according to an embodiment of the present invention, including displays, which are discussed in greater detail below.

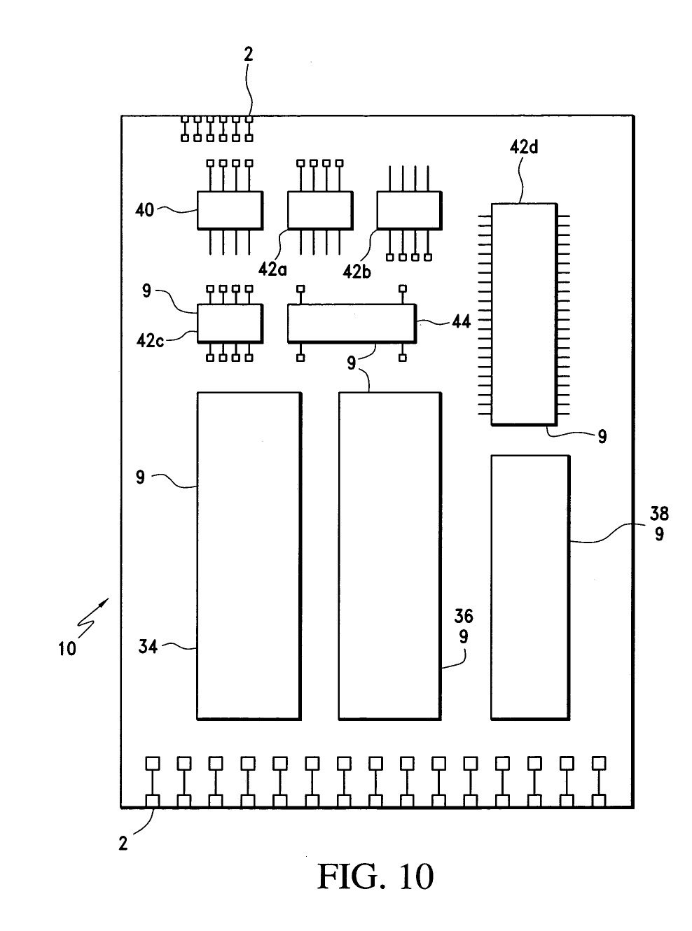

Another type of device that can be created with the direct printing system and processes according to an embodiment of the present invention are displays. These displays can include driver boards that can be created by the direct printing system 200. Types of displays that can be manufactured according to the direct printing system 200 and processes according to an embodiment of the present invention include electronic ink displays, electro-chemical displays, thermo-chromic displays, polymer dispersed liquid display terminals, organic light emitting diode display terminals and polymer organic light emitting diode display terminals. One exemplary use of the displays that can be manufactured according to an embodiment of the present invention include those that can be used on consumer product packages as described in greater detail below. Since the substrate 8 material is relatively inexpensive, and the cost of the direct printing ink composition 26 in significant quantities is also relatively inexpensive, these displays can become consumable, throw-away devices. E-ink displays are well known to those of ordinary skill in the art of the present invention. In an E-ink display, a small electric field is required to change the opacity of the e-ink display in the vicinity of the electric field. Electric fields can be generated by turning on a transistor 12. Thus, the display driver 38 is similar to the programmable PROM 34, except it is configured to be covered by an e-ink display membrane (not shown). A conductive trace 24 is direct printed for each area on the e-ink display where the opacity is desired to be changed. Then, when appropriate signals are received by a display driver 38 (shown in FIG. 10), the e-ink membrane displays the message programmed into the display driver 38.

Thermo-chromic displays work in a similar fashion to that as e-ink displays. One of the differences between the two is the method in which the display material is activated. As discussed above, e-ink display material is activated by producing a small electric field near the display material that causes it to change its opacity. Thermo-chromic display material changes its opaqueness as a result of heat in proximity to the display material. Therefore, in a thermo-chromic display, messages, and designs can be displayed by placing resistors where the desired change in opaqueness of the thermo-chromic display material is to occur. Current is then passed through the resistor, generating heat (power=I2*R) that causes the opaqueness of the thermo-chromic display material to change. The resistors can be arranged in an array, similarly to the array of transistors used in PROMS. The array of resistors can be pre-provided by the manufacturer of the substrate 8. The user can print short conductive traces 24 connecting resistors to driver circuit that provides current under certain conditions, thereby displaying a message on the thermo-chromic display when desired. Alternatively, the manufacturer of the substrate need not provide the resistor array, and the user can print resistors and conductive traces 24 in desired locations to create messages.

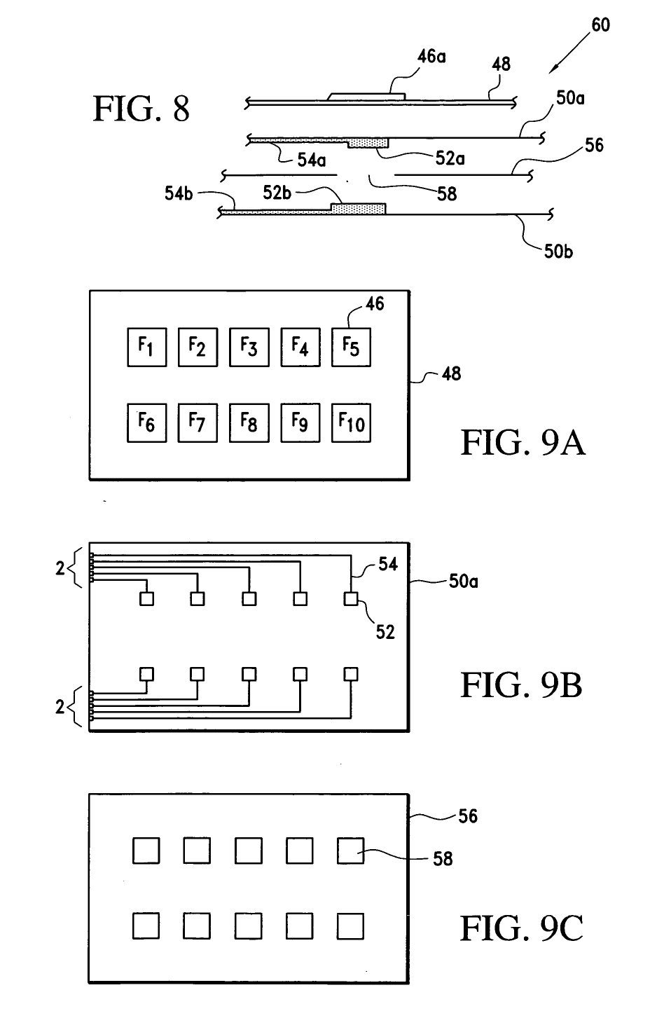

Another example of a device that can be manufactured using the direct printing system 200 and processes described herein according to an embodiment of the present invention are membrane keyboards. FIG. 8 illustrates a membrane keyboard assembly (membrane keyboard) 60 manufactured in part using the direct printing system 200 shown in FIG. 1, and FIGS. 9A-9C illustrate several components pieces of the membrane keyboard assembly shown in FIG. 8. The dust-cover membrane 48 comprises a plurality of key buttons (labeled as F1-F10)46. As one skilled in the art of the present invention can appreciate, the exemplary embodiment of the membrane keyboard 60 shown and described in reference with FIGS. 8 and 9A-9C are merely for purposes of explaining the embodiments of the present invention, and are not to be construed as limiting the embodiments of the present invention in any manner whatsoever.

The membrane keyboard 60 further includes a first trace layer 50a, an insulating membrane 56, and a second trace layer 50i b. The first trace layer 50a, shown also in FIG. 9B, comprises a plurality keyboard buttons 46 (in this non-limiting example 10 keyboard buttons 46) periodically located in an uniform manner. In the membrane keyboard 60, a limited number of keyboard buttons 46 are shown for the purpose of simplifying the drawings and discussion herein. The first trace layer 50a comprises a plurality of key button pads 52, that can either be pre-printed on the pre-provided substrate 8, or designed and direct printed on the substrate 8 using the direct printing system 200 according to an embodiment of the present invention. Furthermore, additional functional blocks of electronic devices 9 can be included on the substrate 8 so that additional electronic functions can be direct printed on the substrate 8. This can include, for example, de-bouncer circuits, and resistors for pull-up and/or pull-down purposes. The user can use the design tool to design the key button conductive traces between the key button pads 52, connectors 2, and any other devices that can be incorporated into the membrane keyboard 60.

In an exemplary embodiment of the present invention, the key button pads 52, whether pre-provided by the manufacturer of the substrate 8, or direct printed by the user, use ink that is especially abrasion resistant. Use of the abrasion resistant ink is useful because of the manner in which the membrane keyboard operates. The two key button pads 52 will necessarily contact each other when the associated membrane keyboard button 46 is pressed by a user. The abrasion resistant ink prevents the key button pads from prematurely wearing out, thereby increasing the life expectancy of the membrane keyboard.

The keyboard membrane 60 further includes an insulating membrane 56, with a corresponding plurality of holes 58. As shown in FIGS. 8 and 9C, the holes 58 are located so that a first key button pad 52a, when its corresponding the keyboard button 46a is pressed by a user, touches a corresponding second key button pad 52b, completing a circuit. The circuit completion can provide a logic level “1” or logic level “0”, as desired and subsequently interconnected, to an attached device (not shown). The insulating membrane keeps the key button conductive traces 54 from touching each other or other components.

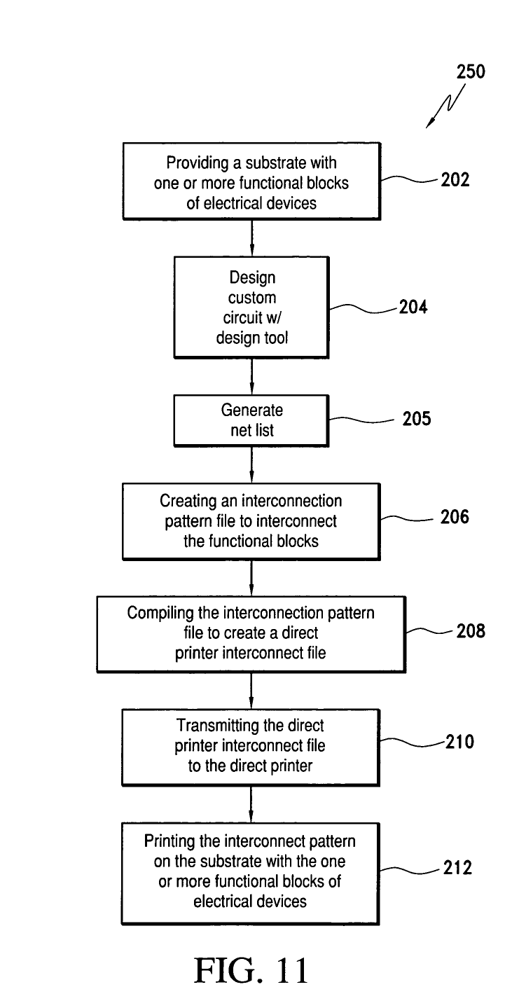

FIG. 10 illustrates a top view of a substrate pre-provided with pre-printed functional blocks of electronic devices 9 and other pre-printed electronic devices 9 for use with the direct printing system 200 shown in FIG. 1, and the process described in reference to FIG. 11 (which is discussed in detail below). In FIG. 10, the functional blocks of electronic devices 9 include a PROM 34, a resistor array 36, a display driver 38, line driver/receiver 40, logic devices 42a-42c, and a processor 44. The configuration of the custom printed circuit board 10 shown in FIG. 10 represents only one exemplary embodiment of the present invention, from among a virtually limitless amount, wherein the major functions of the custom printed circuit board 10 have been carefully provided, but not the exact interconnection, thereby allowing the user to customize the ultimate design as needed from board to board.

The custom printed circuit board 10 in this exemplary embodiment of the present invention is not to be construed, as those of ordinary skill in the art of the present invention can appreciate, as limiting in any manner: the custom printed circuit board 10 shown in FIG. 10 merely provides an illustrative example of how one such custom printed circuit board can be provided to a user. In this instance, the custom printed circuit board 10 is pre-provided with a plurality of electronic device 9. The plurality of electronic devices 9 includes a pre-printed PROM 34, display driver 38, resistor array 36 and other circuits. The resistor array 36 can be used for pull-up or pull-down resistors, current limiting resistors, voltage dividers and other uses. Display driver 38 can either be an array of transistors 12 that can be used to drive an electronic ink (e-ink) display, or a resistor array 36 that can be used to drive a thermo-chromic display, as described above. A specific exemplary use of this custom printed circuit board according to an embodiment of the present invention is in disposable consumer packages. Such packages can be used to persuade a potential customer to purchase the contents therein.

FIG. 11 illustrates a flow diagram of an alternative process 250 for creating a custom printed circuit board 10, as shown in FIG. 10, according to an embodiment of the present invention. In step 202, a user is provided with a substrate 8 that includes one or more pre-provided functional blocks of electronic devices 9. Using the above-described design tool, in step 204, the user designs the custom printed circuit board 10 using the one or more of the pre-provided functional blocks of electronic devices. As discussed above in reference to process 100, designing the custom printed circuit board from the one or more pre-provided functional blocks of electronic devices 9 includes creating an interconnection pattern file in the design tool to connect the one or more functional blocks of electronic circuits from a library that defines the custom printed circuit board 10 in terms of the functional blocks of electronic devices.

Substrate 8, in regard to any of the processes and uses discussed herein, has generally been described as including both direct printed ink resistors, capacitors and transistors, along with standard integrated circuits, albeit in various different packaging technologies (surface mount, dual in line packaging, among others). According to another exemplary embodiment of the present invention, any pre-provided electronic device 9 can be manufactured from polymer based and/or inorganic ink solution. Direct printing of electronic devices using these inks provides several distinct advantages including the reduction of cost, the ability to customize the electronic circuit on the individual substrate, the ability to embed the device inside a multilayer structure, and the ability to hard-wire specific digital information into the device. According to this exemplary embodiment of the present invention, printed transistors can be pre-provided by the manufacturer of the substrate 8 by using a lithographic offset printing process. The lithographic offset printing process provides greater resolution than several of the other direct printing processes, as discussed above. Photolithographic processes (similar to those used in traditional IC manufacturing) can also be used in conjunction with direct deposition processes such as inkjet, spin coat, and high speed printing processes such as offset, flexography, and gravure printing.

In step 204, the user accesses the design tool that includes circuit device symbols of all the pre-provided functional blocks of electronic devices. The design tools available to the user of the direct printing system 200 include a combination of two or more conventional electronic circuit design tools, proprietary software designed for use on a particular embodiment of the direct printing system 200, or can be other well known software design tools for creating electronic circuits. Each type of design tool is well known to those of ordinary skill in the art of the present invention. Examples of well known software design tools for creating electronic circuits include a very high speed integrated circuit (VHSIC) hardware description language (VHDL) software tool.

The user picks-and-places each circuit device symbol onto a circuit board design screen, and draws the interconnections paths (i.e., conductive traces 24) between one or more terminals (i.e., pads) of the circuit device symbols. The design tool can access a separate or integrated library (i.e., one that is provided with the design tool) that contains all the pre-provided functional blocks of electronic devices 9 on the substrate 8. The library, or libraries, can reside in a suitable computer assisted engineering (CAE) software tool.

Once the user completes the design to perform one or more desired electronic functions, the analysis tool can be used to perform an analysis of the design (i.e., does it do what the user thinks it should do), and verify the integrity of the design, i.e., will it still perform accurately under various operating conditions (temperature, voltage changes, among others). The final design is then saved by the design tool. The design tool then creates a net list in step 205. Net lists, as discussed above, are a simple list of interconnected points.

In step 206, the design tool then generates a file of pad interconnection paths, based, in part, on the net list. In step 208, the user compiles the interconnection pattern file to create a direct printer readable interconnection file. The direct printer readable interconnection file is one that can be read by the direct printer system 200, and contains data that specifically directs the direct printer system 200 to put conductive traces in various physical locations. The user can also use a second (or first) analysis tool to verify the integrity of the design. The second analysis tool can be used to verify that, given the exact physical layout the design tool created in the direct printer readable interconnection file, an analysis of design shows that it will still perform accurately under various operating conditions (temperature, voltage changes, among others) with the given characteristics of the pre-provided substrate 8. If the results are not completely to the satisfaction of the user, the user can re-design the custom printed circuit 10, or command the design tool to re-layout the interconnection paths. Step 208 is substantially similar to step 108 of process 100 described above.

In step 210 the direct printing system 200 transmits the direct printer readable interconnection file to the direct printer system 200. In step 212, the direct printer system 200 performs the direct printing process such that one or more conductive traces are printed between the one or more functional blocks of the electronic devises to form the designed custom printed circuit board 10 (again, steps 210, 212 are substantially similar to steps 110, 112 of process 100 described above). According to an exemplary embodiment of the present invention, the step of direct printing includes ink jet printing the one or more conductive paths using an ink composition 26 that includes conductive particles in a solution, and curing the printed ink composition 26 to create a conductive trace 24 with a desired conductivity.

According to an exemplary embodiment of the present invention, the pre-provided functional blocks of electronic circuits include transistors, resistors, capacitors, inductors, buffer circuits, transmitter and receiver circuits, input/output circuit devices, input/output terminals, memory circuits, line drivers, microprocessors, display devices, sensor devices, and the like . According to an exemplary embodiment of the present invention, the transistors can be provided as an array of one or more transistors that have been direct printed on the substrate 10, and the display device can include an e-ink media (or any of the other type of display discussed above) with an array of transistors. The array of transistors can be provided in a programmable read-only memory (ROM) configuration.

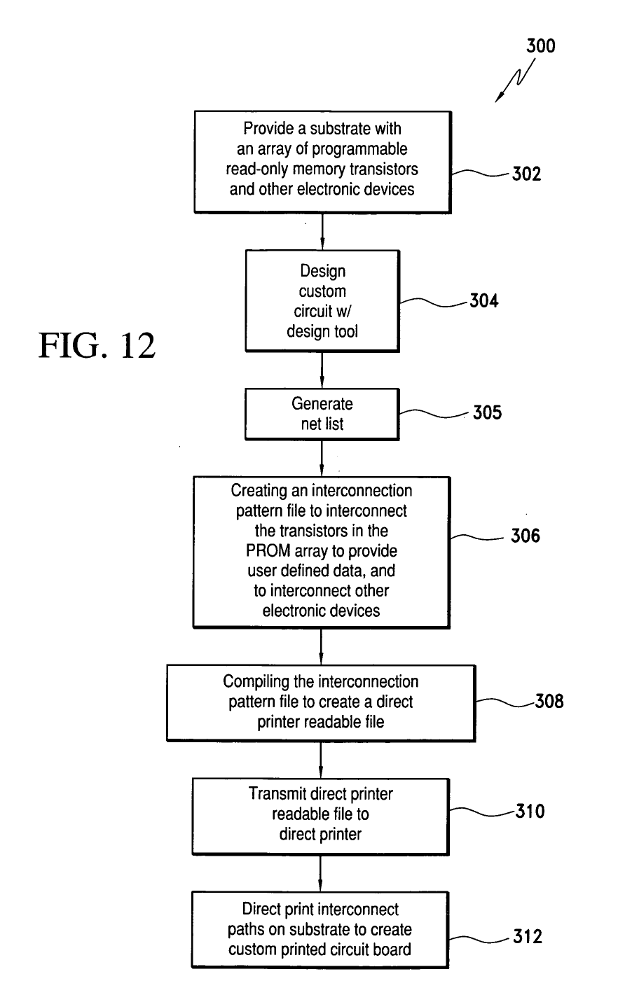

FIG. 12 illustrates a flow diagram of a process 300 for creating a programmable read-only memory (ROM) custom printed circuit board 10 using the direct printing system 200 according to an embodiment of the present invention. Process 300 begins with step 302, in which the user is provided with a substrate that is pre-provided with an array of transistors. The array of transistors is configured as an array of programmable read-only memory transistors. Other electronic devices 9 can also be pre-provided on the substrate 8. The transistors are configured as shown in FIG. 5, which was discussed above. As discussed above, in order to program a logic level “1”, a conductive trace 24 must be placed between emitter pad 14 and fuse pad 32. If a logic level “0” is desired, no conductive trace 24 is printed for that particular memory location.

In step 304, the user uses the design tool to design the custom printed circuit, in this case, a programmable read-only memory (PROM). In step 304, the user, with the design tool, creates the design of the PROM with user defined data. User defined data defines the digital information, or data, that is to be stored in the PROM, and can be obtained from many different sources. According to an exemplary embodiment of the present invention, the user defined data can originate from a keyboard associated with the direct printer system 200, or a stand alone PC, among other sources. In addition, the user can use the design tool to create additional interconnections between the transistors of the PROM array, and the other electronic devices 9 that can be pre-provided on the substrate 8. For example, printing conductive traces 24 to and from the terminal connectors 8 provides external access to the user defined data, and printing from the PROM transistor array to a processor provides internal access to the user defined data. As one of ordinary skill in the art can appreciate, the design tools available to the user can create a PROM design based on user defined data substantially automatically. Following step 304, the balance of the process 300 is substantially similar to that described in reference to process 100, and will not be discussed in detail for purposes of brevity. In step 305, a net list is generated; in step 306, an interconnection pattern file is generated using data from the net list; in step 308 the interconnection pattern file is compiled into a format that the direct printer system 200 can understand (this need not be electronic, as discussed above: in the case of lithographic offset printing (and gravure printing), physical plates are made from the interconnection pattern file(s)); in step 310, the direct printer readable file is transmitted to the direct printer system 200; and in step 312, the interconnection paths (or simple electronic devices 9) are printed on the substrate 8.

All United States patents and applications, foreign patents, and publications discussed above are hereby incorporated herein by reference in their entireties.

The present invention has been described with reference to certain exemplary embodiments thereof. However, it will be readily apparent to those skilled in the art that it is possible to embody the invention in specific forms other than those of the exemplary embodiments described above. This may be done without departing from the spirit and scope of the invention. The exemplary embodiments are merely illustrative and should not be considered restrictive in any way. The scope of the invention is defined by the appended claims and their equivalents, rather than by the preceding description.

What is claimed is:

1. A process for creating a custom printed circuit comprising:
a) providing a substrate with one or more electronic devices, wherein each electronic device comprises a plurality of terminals, each of the plurality of terminals electrically connected to at least one or more terminal pads; and
b) direct printing one or more conductive paths between the plurality of terminal pads to create one or more custom printed circuits.

2. The process according to claim 1, wherein the one or more electronic devices are selected from the group consisting of transistors, resistors, capacitors, inductors, buffer circuits, transmitter and receiver circuits, input/output circuit devices, input/output terminals, memory circuits, line drivers, microprocessors, display devices, and sensor devices.

3. The process according to claim 1, wherein the one or more electronic devices comprises:
an array of one or more transistors.

4. The process according to claim 1, wherein the one or more electronic devices comprises:
one or more transistors previously interconnected to provide a function of the one or more electronic devices.

5. The process according to claim 1, wherein the substrate comprises a flexible, substantially non-rigid substrate.

6. The process according to claim 1, wherein the substrate comprises a substantially non-flexible, substantially rigid substrate.

7. The process according to claim 1, wherein the step of direct printing one or more conductive paths comprises:
a) ink jet printing the one or more conductive paths using an ink that comprises conductive particles in a solution; and
b) curing the printed ink to create a path with a desired conductivity.

8. The process according to claim 1, further comprising:
a) defining one or more interconnection paths between the one or more terminal pads of the one or more electronic devices, wherein such interconnection paths defines a custom printed circuit with an electronic function;
b) generating a series of commands to create the one or more interconnection paths for use with a direct printer device; and
c) transmitting the series of commands to the direct printer device.

9. The process according to claim 8, wherein the direct printer device comprises:
an ink jet printer.

10. The process according to claim 8, wherein the step of defining one or more interconnection paths between the one or more terminal pads of the one or more electronic devices comprises:
a) designing the custom printed circuit from a library that defines the custom printed circuit in terms of the one or more electronic devices provided on the substrate; and
b) generating a file comprising the one or more interconnection paths between the one or more terminal pads of the one or more electronic devices from the library that defines the custom printed circuit in terms of the one or more electronic devices provided on the substrate.

11. The process according to claim 10, wherein the library is obtained from a computer assisted engineering (CAE) software tool.

12. The process according to claim 8, wherein the step of defining one or more interconnection paths between the one or more terminal pads of the one or more electronic devices comprises:
a) utilizing a design tool that defines the custom printed circuit in terms of the one or more electronic devices provided on the substrate; and
b) generating a file comprising the one or more interconnection paths between the one or more terminal pads of the one or more electronic devices from the design tool that defines the custom printed circuit in terms of the one or more electronic devices provided on the substrate.

13. The process according to claim 12, wherein the design tool is obtained from a very high speed integrated circuit (VHSIC) hardware description language (VHDL) software tool.

14. The process according to claim 8, wherein the step of generating a file comprises:
a) compiling the file generated by the library comprising the one or more interconnection paths between the one or more terminal pads of the one or more electronic devices into a file that can be read by the direct printer device.

15. The process according to claim 1, wherein the custom printed circuit comprises a driver board for a display terminal.

16. The process according to claim 15, wherein the display terminal comprises an electronic ink display terminal.

17. The process according to claim 15, wherein the display terminal comprises an electro-chromic display terminal.

18. The process according to claim 15, wherein the display terminal comprises an thermo-chromic display terminal.

19. The process according to claim 18, further comprising:
printing a resistor device along the conductive path between the plurality of conductive terminal pads to create heat from the resistor device.

20. The process according to claim 15, wherein the display terminal comprises a polymer dispersed liquid crystal display terminal.

21. The process according to claim 15, wherein the display terminal comprises an organic light emitting diode display terminal.

22. The process according to claim 15, wherein the display terminal comprises a polymer organic light emitting diode display terminal.

23. The process according to claim 1 wherein the custom printed circuit comprises a ROM.

24. The process according to claim 1 wherein the custom printed circuit comprises a customized display for a package.

25. A process for creating a custom printed circuit from pre-provided functional blocks of electronic circuits on a substrate, comprising:
a) designing the custom printed circuit from one or more functional blocks of electronic circuits; and
b) direct printing one or more conductive traces between the one or more functional blocks of electronic circuits to form the designed custom printed circuit.

26. The process according to claim 25, wherein the step of direct printing comprises:
a) ink jet printing the one or more conductive paths using an ink that comprises conductive particles in a solution; and
b) curing the printed ink to create a path with a desired conductivity.

27. The process according to claim 25, wherein the step of designing the custom printed circuit comprises:
a) creating an interconnection pattern file to connect the one or more functional blocks of electronic circuits from a library that defines the custom printed circuit in terms of the functional blocks;
b) compiling the interconnection pattern file to create a direct printer readable interconnection file; and
c) transmitting the direct printer readable interconnection file to the direct printer.

28. The process according to claim 27, wherein the library is obtained from a computer assisted engineering (CAE) software tool.

29. The process according to claim 27, wherein the direct printer device comprises:
an ink jet printer.

30. The process according to claim 25, wherein the step of designing the custom printed circuit comprises:
a) creating an interconnection pattern file to connect the one or more functional blocks of electronic circuits from a design tool that defines the custom printed circuit in terms of the functional blocks;
b) compiling the interconnection pattern file to create a direct printer readable interconnection file; and
c) transmitting the direct printer readable interconnection file to the direct printer.

31. The process according to claim 30, wherein the design tool is obtained from a very high speed integrated circuit (VHSIC) hardware description language (VHDL) software tool.

32. The process according to claim 25, wherein the pre-provided functional blocks of electronic circuits are selected from the group consisting of transistors, resistors, capacitors, inductors, buffer circuits, transmitter and receiver circuits, input/output circuit devices, input/output terminals, memory circuits, line drivers, microprocessors, display devices, and sensor devices.

33. The process according to claim 32, wherein the one or more pre-provided functional blocks of electronic devices comprises:
an array of one or more transistors.

34. The process according to claim 25, further comprising:
providing a substrate with one or more transistors that have been direct printed on the substrate.

35. The process according to claim 34, wherein the step of providing a substrate with one or more transistors that have been direct printed on the substrate comprises:
ink jet printing an array of transistors.

36. The process according to claim 25, wherein the pre-provided functional blocks of electronic circuits comprises:
a) an e-ink media with flexible substrate with an array of transistors.

37. The process according to claim 25, wherein the pre-provided functional blocks of electronic circuits comprises:
a) a flexible substrate with an array of transistors provided in a fusible read-only memory (ROM) configuration.

38. The process according to claim 25, wherein the custom printed circuit comprises:
a display device, display driver device or a read-only memory (ROM) device.

39. The process according to claim 25, wherein the substrate comprises a flexible, substantially non-rigid substrate.

40. The process according to claim 25, wherein the substrate comprises a substantially non-flexible, substantially rigid substrate.

41. A process for providing user defined data in a configurable read-only memory device (ROM), wherein the ROM comprises an array of transistors on a substrate, the process comprising:
a) direct printing a first interconnect pattern within the array of transistors to provide the user defined data; and
b) direct printing a second interconnect pattern to provide external and/or internal access to the user defined data.

42. The process according to claim 41, wherein the step of direct printing an interconnect pattern comprises:
a) ink jet printing the interconnect pattern using an ink that comprises conductive particles in a solution; and
b) curing the printed ink to create a path with a desired conductivity.

43. The process according to claim 41, wherein the step of direct printing a first interconnect pattern comprises:
a) direct printing a first conductive path between a first group of conductive pads associated with a first group of transistors in the array of transistors where a high logic level is desired; and
b) not direct printing a conductive path between a second group of conductive pads associated with a second group of transistors in the array of transistors where a low logic level is desired.

44. The process according to claim 41, further comprising:
a) pre-providing one or more functional blocks of electronic circuits on a substrate;
b) designing a custom printed circuit from one or more functional blocks of electronic circuits and the ROM; and
c) direct printing one or more conductive traces between the one or more functional blocks of electronic circuits to form the designed custom printed circuit.

45. The process according to claim 44, wherein the step of direct printing comprises:
a) ink jet printing the one or more conductive paths using an ink that comprises conductive particles in a solution; and
b) curing the printed ink to create a path with a desired conductivity.

46. The process according to claim 44, wherein the step of designing the custom printed circuit comprises:
a) creating an interconnection pattern file to connect the one or more functional blocks of electronic circuits and the ROM from a library that defines the custom printed circuit in terms of the functional blocks;
b) compiling the interconnection pattern file to create a direct printer readable interconnection file; and
c) transmitting the direct printer readable interconnection file to the direct printer.

47. The process according to claim 46, wherein the library is obtained from a computer assisted engineering (CAE) software tool.

48. The process according to claim 46, wherein the direct printer device comprises:
an ink jet printer.

49. The process according to claim 44, wherein the step of designing the custom printed circuit comprises:
a) creating an interconnection pattern file to connect the one or more functional blocks of electronic circuits and the ROM from a design tool that defines the custom printed circuit in terms of the functional blocks;
b) compiling the interconnection pattern file to create a direct printer readable interconnection file; and
c) transmitting the direct printer readable interconnection file to the direct printer.

50. The process according to claim 49, wherein the design tool is obtained from a very high speed integrated circuit (VHSIC) hardware description language (VHDL) software tool.

51. The process according to claim 44, wherein the pre-provided functional blocks of electronic circuits are selected from the group consisting of transistors, resistors, capacitors, inductors, buffer circuits, transmitter and receiver circuits, input/output circuit devices, input/output terminals, memory circuits, line drivers, microprocessors, display devices, and sensor devices.

52. The process according to claim 51, wherein the one or more pre-provided functional blocks of electronic devices comprises:
an array of one or more transistors.

53. The process according to claim 41, further comprising:
providing a substrate with one or more transistors that have been direct printed on the substrate.

54. The process according to claim 53, wherein the step of providing a substrate with one or more transistors that have been direct printed on the substrate comprises:
ink jet printing an array of transistors.

55. The process according to claim 44, wherein the pre-provided functional blocks of electronic circuits comprises:
a) an RF antenna and a power source.

56. The process according to claim 41, wherein the substrate comprises a flexible, substantially non-rigid substrate.

57. The process according to claim 41, wherein the substrate comprises a substantially non-flexible, substantially rigid substrate.

58. A process for creating a custom printed circuit from pre-provided functional blocks of electronic circuits and standard integrated circuits, comprising:
a) designing the custom printed circuit from one or more functional blocks of electronic circuits and at least one or more standard integrated circuits; and
b) direct printing one or more conductive traces between the one or more functional blocks of electronic circuits and the at least one or more standard integrated circuits to form the designed custom printed circuit.

59. The process according to claim 58, wherein the step of direct printing comprises:
a) ink jet printing the one or more conductive paths using an ink that comprises conductive particles in a solution; and
b) curing the printed ink to create a path with a desired conductivity.

60. The process according to claim 58, wherein the step of designing the custom printed circuit comprises:
a) creating an interconnection pattern file to connect the one or more functional blocks of electronic circuits and the at least one or more standard integrated circuits from a library that defines the custom printed circuit in terms of the functional blocks;
b) compiling the interconnection pattern file to create a direct printer readable interconnection file; and
c) transmitting the direct printer readable interconnection file to the direct printer.

61. The process according to claim 60, wherein the library is obtained from a computer assisted engineering (CAE) software tool.

62. The process according to claim 60, wherein the direct printer device comprises:
an ink jet printer.

63. The process according to claim 58, wherein the step of designing the custom printed circuit comprises:
a) creating an interconnection pattern file to connect the one or more functional blocks of electronic circuits and the at least one or more standard integrated circuits from a design tool that defines the custom printed circuit in terms of the functional blocks;
b) compiling the interconnection pattern file to create a direct printer readable interconnection file; and
c) transmitting the direct printer readable interconnection file to the direct printer.

64. The process according to claim 63, wherein the design tool is obtained from a very high speed integrated circuit (VHSIC) hardware description language (VHDL) software tool.

65. The process according to claim 58, wherein the one or more pre-provided functional blocks of electronic circuits are selected from the group consisting of transistors, resistors, capacitors, inductors, buffer circuits, transmitter and receiver circuits, input/output circuit devices, input/output terminals, memory circuits, line drivers, microprocessors, display devices, and sensor devices.

66. The process according to claim 58, wherein the one or more pre-provided functional blocks of electronic circuits comprises:
a) an array of one or more transistors.

67. The process according to claim 58, wherein the at least one or more standard integrated circuits comprises:
a) one or more of a counter circuit, processor circuit, timer circuit, logic circuits, sensor circuits, display circuits, and input/output circuits.

68. The process according to claim 58, further comprising:
a) providing a substrate with one or more transistors that have been direct printed on the substrate.

69. The process according to claim 68, wherein the step of providing a substrate with one or more transistors that have been direct printed on the substrate comprises:
a) ink jet printing an array of transistors.

70. The process according to claim 58, wherein the pre-provided functional blocks of electronic circuits comprises:
a) an e-ink media with flexible substrate with an array of transistors.

71. The process according to claim 58, wherein the pre-provided functional blocks of electronic circuits comprises:
a) a flexible substrate with an array of transistors provided in a fusible read-only memory (ROM) configuration.

72. The process according to claim 58, wherein the custom printed circuit comprises:
a display device, display driver device or a read-only memory (ROM) device.

73. The process according to claim 58, wherein the substrate comprises a flexible, substantially non-rigid substrate.

74. The process according to claim 58, wherein the substrate comprises a substantially non-flexible, substantially rigid substrate.

75. A process for creating a membrane keyboard device from a plurality of substrates, wherein each substrate comprises a pre-provided array of transistors and at least one or more standard integrated circuits, the process comprising:
a) direct printing a plurality of conductive traces for a first membrane of the membrane keyboard onto a first substrate, and direct printing a second plurality of conductive traces for a second membrane of the membrane keyboard onto a second substrate; and
b) direct printing one or more conductive traces from either or both of one or more transistors from the array of transistors and one or more of the standard integrated circuits to at least one or more of the plurality of traces printed on the first and second membranes.

76. The process according to claim 75, wherein the step of direct printing the conductive traces comprises:
a) ink jet printing the conductive traces using an ink that comprises conductive particles in a solution; and
b) curing the printed ink to create a trace with a desired conductivity.
